(19) United States
(12) Patent Application Publication
(10) Pub. No.: US 2023/0055830 A1
(43) Pub. Date: Feb. 23, 2023

(54) MULTI-PHASE MATERIAL-CONTAINING COMPOSITIONS AND RELATED METHODS OF PREPARATION AND USE

(71) Applicants: Advanced Potash Technologies, Ltd., Grand Cayman (KY); Ingo Wender, Rio de Janeiro (BR)

(72) Inventors: Ingo Wender, Rio de Janeiro (BR); Dennis Chen, Boston, MA (US); Jennifer Le Blond, Arlington, MA (US); Vannara Diep, Pelham, NH (US); Marcos Rodrigues, Piracicaba (BR); Juliana Sato, Brasília (BR); Marcelo De Oliveira, Arlington, MA (US)

(21) Appl. No.: 17/791,830

(22) PCT Filed: Feb. 17, 2021
(86) PCT No.: PCT/IB2021/051351

§ 371 Date: Jul. 8, 2022

Related U.S. Application Data
(60) Provisional application No. 62/977,948, filed on Feb. 18, 2020.

(51) Int. Cl. C05D 1/02; C05G 1/00; C05D 3/00; C05D 9/02; C05C 9/00

(52) U.S. Cl. CPC C05D 1/02; C05G 1/00; C05D 3/00; C05D 9/02; C05C 9/00

(57) ABSTRACT

A method, comprising: heating at a temperature of at least 90° C. for a time of at least 10 minutes and a pressure of at least one atmosphere: 1) a potassic framework silicate ore; 2) at least one material selected from the group consisting of an oxide, a hydroxide, and a carbonate of at least one of an alkaline earth metal and an alkali metal; and 3) water, thereby producing a first product; combining the first product with a source of a component to form a second product; and drying the second product to provide a composition comprising an MPM and the component, wherein the source of the component comprises at least one member selected from the group consisting of KCl, a macronutrient source, a micronutrient source and a source of a beneficial element. A composition, comprising: an MPM; and a component selected from the group consisting of a KCl, a macronutrient, a micronutrient and a beneficial element, wherein the MPM comprises at least two phases selected from the group consisting of K-feldspar phase, tobermorite phase, hydrogrossular phase, dicalcium silicate hydrate phase and amorphous phase.

### CROSS-REFERENCE TO RELATED APPLICATION

The present application claims benefit under 35 U.S.C. § 119 of U.S. Ser. No. 62/977,948, filed Feb. 18, 2020, and entitled “PROCESSING POTASSIUM RESERVES TO GENERATE A MULTI-STAGE FERTILIZER,” the entire contents of which are incorporated by reference herein.

### FIELD

The disclosure relates to multi-phase material-containing compositions and related methods of preparation and use.

### BACKGROUND

Potassium chloride (KCl), sometimes referred to as muriate of potash (MOP), is a common source of potassium (K) in fertilizers. It is known to use K-feldspar as a starting material to produce potassium source materials.

### SUMMARY

K-feldspar is one of the most abundant aluminosilicate minerals from the earth's crust. However, without further processing, the immediate effect it has on soil is in most cases limited. As an example, the K within the K-feldspar minerals is largely inaccessible because it is bound to the framework of the mineral. Natural weathering processes can release some of the trapped K. This process formed the world's ancient fertile soils, but natural weathering rates of K-feldspar occur far slower than what is required to replenish the nutrients for agronomic soil use.

The disclosure provides compositions, as well as related methods of preparation and use, that can overcome one or more limitations of K-feldspar. In some embodiments, the compositions can build-up the overall fertility of a soil, improve the health and life of the soil, and recover degraded and exhausted soils. Additionally or alternatively, the compositions can reduce leaching losses of one or more components of the composition. As an example, in some embodiments in which a composition includes a multi-phase material and KCl, leaching losses of K can be decreased when compared to leaching that would occur with solely KCl. In certain embodiments, the disclosure provides improved K-bearing fertilizers and/or compositions that provide one or more nutrients (macronutrients and/or micronutrients) and/or other beneficial elements to crops and/or soils. In certain embodiments in which a composition contains one or more nutrients (macronutrients and/or micronutrients) and/or other beneficial elements, leaching losses of the nutrient(s) and/or other beneficial element(s) can be reduced. The disclosure also provides compositions that can exhibit higher performance and/or higher yield. Generally, the processes for making the compositions can be relatively simple and inexpensive. As a result, in general, the technology can be relatively easy and inexpensive to implement on an industrial scale.

Generally, the compositions disclosed herein include a multi-phase material (MPM) and at least one additional component.

As used herein, an MPM is a material that includes at least two phases (e.g., two phases, three phases, four phases, five phases) selected from K-feldspar phase, tobermorite phase, hydrogrossular phase, dicalcium silicate hydrate and amorphous phase.

Examples of additional components include KCl (sylvite phase), macronutrients (nitrogen (N), phosphorus (P), potassium (K), calcium (Ca), magnesium (Mg) and sulfur (S)), micronutrients (boron (B), chlorine (Cl), copper (Cu), iron (Fe), manganese (Mn), molybdenum (Mo), nickel (Ni) and zinc (Zn)) and/or other beneficial elements (e.g., sodium (Na), selenium (Se), silicon (Si), cobalt (Co) and vanadium (V)).

Generally, an MPM can be prepared according to any appropriate process. As discussed in more detailed elsewhere herein, in some embodiments, an MPM is prepared by a hydrothermal process, followed by drying. A hydrothermal process for preparing an MPM can include, for example, reacting an alkali metal silicate with: i) an oxide, a hydroxide and/or a carbonate of at least one of an alkaline earth metal and an alkali metal; and ii) water, at a temperature between 90° C. and 400° C. (e.g., 100° C. and 400° C.), a pressure between one atmosphere (atm) to 300 atm and for a time period of from 0.01 hour (h) to six h. As an example, in certain embodiments, an MPM is prepared by reacting K-feldspar syenite with calcium oxide (CaO) at a temperature between 90° C. and 400° C. (e.g., 100° C. and 400° C.), to a pressure between one atm to 300 atm for a time period of from 0.01 h to six h, followed by drying. In some embodiments, a hydrothermal process is performed using an autoclave.

In general, any appropriate method can be used to make compositions that include an MPM and at least one additional component. In some embodiments, a method of making a composition involves blending at least substantially dry (e.g., completely dry) MPM with at least one additional component. In some embodiments, a method of making a composition involves combining at least one additional component with the intermediate product formed during MPM production after hydrothermal processing but before drying, thereby forming an intermediate combination, followed by drying the intermediate combination. In some embodiments, a method includes combining at least one additional component with the starting materials for an MPM preparation to provide a combination, followed by hydrothermal processing and drying of the combination. Combinations of such methods can be used.

Without wishing to be bound by theory, it is believed that the multiple different phases present in an MPM allow for the possibility of timing/staging the release of the additional component(s) from the composition. Thus, it is possible to tailor a given composition to achieve a particular desired release profile of the additional component(s).

In some embodiments, the disclosure provides a process for the preparation of compositions, for example, with potential application in agriculture as a fertilizer (e.g., by providing the one or more additional components in the composition) and/or in soil remediation (e.g., by immobilizing heavy metals from the soil). In certain embodiments, the present disclosure can provide a process for the preparation of compositions that can significantly increase crop yields and improve soil health, compared, for example, with a standalone KCl fertilizer. The present disclosure provides compositions with different rates and patterns of release of the one or more additional components. For example, in the case of K-release, the compositions can combine highly water-soluble KCl with the unique properties of MPMs such that compositions exhibit relatively quick K-release in addition to multi-staged/slow K-release. In some cases, the compositions provide multi-stage release of the one or more additional components, a high cation-adsorption capacity, a beneficial agronomic residual effect, an ability to buffer soil pH at optimal levels for a given crop, a microbiome friendly property, and/or a low salinity. In certain embodiments, the compositions can supply one or more nutrients and/or one or more beneficial elements to the crops for a relatively long period of time (e.g., an entire season). In some embodiments, this can be achieved through a single application. This can save, for example, application costs and/or reduce the demand for short-season manual labor. Additionally or alternatively, this can improve agronomic performance through, for example, reduction of stress and/or specific toxicity resulting from excessive nutrient supply in the root zones.

The disclosure allows for tailoring a process to yield a composition having desired properties. As an example, process parameters may be manipulated to yield a composition with a relatively high cation exchange capacity (CEC) or a relatively low CEC. Without wishing to be bound by theory, it is believed that a relatively high CEC and/or weight percentage of tobermorite may be desirable for a composition to be used in soil remediation (e.g., immobilization of one or more heavy metals from the soil). Without wishing to be bound by theory, it is believed that the relatively low or high CEC values and/or weight percentage of tobermorite are influenced by time periods and/or temperatures for hydrothermal processing. Optionally, various compositions having different CEC values can be combined as desired to achieve an overall composition which exhibits combinations of CEC properties.

Optionally, the process yields a composition that includes an MPM and KCl (sylvite phase). Such a composition can, for example, include K-feldspar phases in a range between 1% and 74.5% by weight, tobermorite phase(s) in a range between 0% and 55% by weight (e.g., between 0% and 50% by weight, between 0% and 45% by weight, between 0% and 40% by weight, between 0% and 35% by weight, between 0% and 30% by weight, between 0% and 25% by weight, between 0% and 20% by weight), hydrogrossular phase(s) in a range between 0% and 15% by weight (e.g., between 0% and 12% by weight), dicalcium silicate hydrate phase in a range between 0% and 20% by weight (e.g., between 0% and 15% by weight, between 0% and 12% by weight, between 0% and 10% by weight), amorphous phase in a range between 0% and 55% by weight (e.g., between 0% and 45% by weight), sylvite phase in a range between 0.1% and 99% by weight and accessories phase in a range between 0% and 20% by weight. Generally, such a composition can be prepared according to any of the various methods disclosed herein. The materials used in such methods (e.g., K-feldspar syenite and CaO) are typically environmentally stable and non-hazardous materials, which are usually abundant, affordable, easy to work with, and readily available in bulk volumes worldwide. In general, the KCl can be introduced in any appropriate form, such as, for example, as crystals, salts, powder, liquid (e.g., solution) and/or slurry. While the foregoing discussion in this paragraph refers to specifically to KCl, more generally, one or more of any of the other additional components disclosed herein can be used instead of, or in addition to, KCl.

The disclosure provides, for example, methods for preparing K and other soil health and nutrient source compositions that have improved properties compared to certain known materials. For example, KCl can dissolve relatively rapidly in a manner that can result in a relatively sudden increase of local K⁺ and Cl⁻ concentrations that can drastically perturb the equilibria between exchangeable and non-exchangeable K in the soil, which can be a detriment for seedlings and/or salt-sensitive systems. In some instances, a substantial fraction of this K is lost by systemic leaching, a phenomenon that can proceed at a relatively slow rate in temperate soils but is exaggerated in tropical soils because of the climatic conditions. The present disclosure provides, in various embodiments, compositions providing relatively immediate release of K (e.g., from soluble portions of a composition) and/or extended/staged release of K. While the foregoing discussion in this paragraph refers to specifically to KCl, more generally, any of the additional components disclosed herein can be used instead of, or in addition to, KCl.

In a general aspect, the disclosure provides a method that includes: heating at a temperature of at least 90° C. for a time of at least 10 minutes and a pressure of at least one atmosphere: 1) a potassic framework silicate ore; 2) at least one material selected from the group consisting of an oxide, a hydroxide, and a carbonate of at least one of an alkaline earth metal and an alkali metal; and 3) water, thereby producing a first product; combining the first product with a source of a component to form a second product; and drying the second product to provide a composition including an MPM and the component, wherein the source of the component includes at least one member selected from the group consisting of KCl, a macronutrient source, a micronutrient source and a source of a beneficial element.

In a general aspect, the disclosure provides a method that includes: heating at a temperature of at least 90° C. for a time of at least 10 minutes and a pressure of at least one atmosphere: 1) a potassic framework silicate ore; 2) at least one material selected from the group consisting of an oxide, a hydroxide, and a carbonate of at least one of an alkaline earth metal and an alkali metal; and 3) water, thereby producing a first product; drying the first product to provide a second product; and combining the second product with a source of a component to provide a composition including the MPM and the component, wherein the source of the component includes at least one member selected from the group consisting of KCl, a macronutrient source, a micronutrient source and a source of a beneficial element.

In a general aspect, the disclosure provides a method that includes: heating at a temperature of at least 90° C. for a time of at least 10 minutes and a pressure of at least one atmosphere: 1) a potassic framework silicate ore; 2) at least one material selected from the group consisting of an oxide, a hydroxide, and a carbonate of at least one of an alkaline earth metal and an alkali metal; 3) water; and 4) a source of a component, thereby producing a first product; and drying the first product to provide a composition including an MPM and the component, wherein the source of the component includes at least one member selected from the group consisting of KCl, a macronutrient source, a micronutrient source and a source of a beneficial element.

In a general aspect, the disclosure provides a composition, including: an MPM; and a component selected from the group consisting of a KCl, a macronutrient, a micronutrient and a beneficial element, wherein the MPM includes at least two phases selected from the group consisting of K-feldspar phase, tobermorite phase, hydrogrossular phase, dicalcium silicate hydrate phase and amorphous phase.

In some embodiments, the at least one material includes at least two materials selected from the group consisting of an oxide, a hydroxide and a carbonate of at least one of an alkaline earth metal and an alkali metal.

In some embodiments, the at least one material includes an oxide, a hydroxide, and a carbonate of at least one of an alkaline earth metal and an alkali metal.

In some embodiments, the pressure is at most 300 atmospheres.

In some embodiments, the temperature is at most 400° C.

In some embodiments, the time is at most six hours.

In some embodiments, the first product includes a slurry including a precursor of the MPM.

In some embodiments, the second product includes the MPM.

In some embodiments, drying is performed at a temperature of at least between 25° C. and/or at a temperature of at most 200° C.

In some embodiments, drying occurs at a pressure of at least one atmosphere and/or at a pressure of at most 100 atmospheres.

In some embodiments, drying occurs for at least 0.01 hour and/or at most 72 hours.

In some embodiments, heating occurs in an autoclave.

In some embodiments, the potassic framework silicate ore includes at least one member selected from the group consisting of K-feldspar, kalsilite, nepheline, trachyte, rhyolite, ultrapotassic syenite, leucite, nepheline syenite, phonolite, fenite, aplite and pegmatite. For example, in some embodiments, the potassic framework silicate ore includes K-feldspar.

In some embodiments, the at least one material includes at least one member selected from the group consisting of lithium (Li), sodium (Na), and potassium (K), beryllium (Be), magnesium (Mg), calcium (Ca), strontium (Sr).

In some embodiments, the at least one material includes at least one member selected from the group consisting of CaO, Ca(OH)₂ and CaCO₃.

In some embodiments, at least one of the following holds: the at least one material includes CaO in a molar ratio of Ca:Si of between 0.05 and 0.6; the at least one material includes Ca(OH)₂ in a molar ratio of Ca:Si between 0.05 and 0.6; and the at least one material includes CaCO₃ in a molar ratio of Ca:Si between 0.05 and 0.6.

In some embodiments, the composition has a weight ratio of MPM:KCl of at least 0.1:1 and/or a weight ratio of MPM:KCl of at most 100:1.

In some embodiments, a method further includes granulating. In some embodiments, granulating is performed after drying.

In some embodiments, an amount of K⁺ released from the composition after a 30 minute to a 100-fold excess of deionized ranges from about 0.2 grams to about 520 grams K⁺ per kilogram of the composition.

In some embodiments, an amount of K⁺ released from the composition after a 30 minute exposure to a 100-fold excess of acid is at least 676-fold higher than an amount of K⁺ released by the potassic framework silicate ore under the same extraction conditions.

In some embodiments, an amount of K⁺ released from the composition after a 30 min exposure to a 100-fold excess of water is at least 2650 times higher than an amount of K⁺ released by the potassic framework silicate ore under the same extraction conditions.

In some embodiments, a ratio of immediate-release potassium to slow release potassium in the composition is from about 720:1 to about 0.01:1.

In some embodiments, a percentage of Cl⁻in the composition is between 0.5% and 45%.

In some embodiments, the source of the component includes at least one member selected from the group consisting of a macronutrient source, a micronutrient source and a source of a beneficial element.

In some embodiments, the source of the component includes KCl.

In some embodiments, wherein the source of the component includes a source of a member selected from the group consisting of N, P, K, Ca, Mg, S, B, Cl, Cu, Fe, Mn, Mo, Ni, Zn, Na, Se, Si, Co and V.

In some embodiments, the source of the component is added before heating.

In some embodiments, the source of the component is added after heating but before drying.

In some embodiments, the source of the component is added after drying.

In some embodiments, the MPM includes at least two phases (e.g., at least three phases, at least four phases, each phase) selected from the group consisting of K-feldspar phase, tobermorite phase, hydrogrossular phase, dicalcium silicate hydrate phase and amorphous phase.

In some embodiments, the MPM includes at least 1% by weight of K-feldspar phase and/or at most 74.5% by weight of K-feldspar phase.

In some embodiments, the MPM includes at least 0.1% by weight of tobermorite phase and/or at most 55% by weight of tobermorite phase.

In some embodiments, the MPM includes at least 0.1% by weight of hydrogrossular phase and/or at most 15% by weight of hydrogrossular phase.

In some embodiments, the MPM includes dicalcium silicate hydrate phase. For example, in some embodiments, the MPM includes at most 20% by weight of dicalcium silicate hydrate phase.

In some embodiments, the MPM includes amorphous phase. For example, in some embodiments, the MPM includes at most 55% by weight of amorphous phase.

In some embodiments, the composition includes at least 0.1% by weight of KCl and/or at most 99% by weight of KCl.

In some embodiments, the MPM further includes accessories phase. For example, in some embodiments, the MPM includes at least 0.1% by weight of accessories phase and/or at most 20% by weight of accessories phase.

In some embodiments, the composition has a salinity index of between 5% and 119%.

In some embodiments, the composition includes K-feldspar phase in a range of between 1% and 74.5% by weight, tobermorite phase in a range of between 0.1% and 55% by weight, hydrogrossular phase in a range of between 0.1% and 15% by weight, dicalcium silicate hydrate phase in a range of between 0% and 20% by weight, amorphous phase in a range of between 0% and 55% by weight, sylvite phase in a range of between 0.1% and 99% by weight and accessories phase in a range of between 0.1% and 20% by weight.

In some embodiments, a percentage of K⁺ in the composition is between 5% and 55%.

In some embodiments, the composition is a fertilizer.

In some embodiments, the composition includes a soil remediation composition.

In some embodiments, the composition includes a soil decontaminate composition.

In some embodiments, the composition includes a crop yield increasing composition.

In some embodiments, the composition includes a soil health improvement composition.

In some embodiments, the composition is configured to release, at different rates, at least one member selected from the group consisting of N, P, K, Ca, Mg, S, B, Cl, Cu, Fe, Mn, Mo, Ni, Zn, Na, Se, Si, Co and V.

In some embodiments, the composition is configured to release at least one macronutrient to soil at different rates.

In some embodiments, the composition is configured to release at least one micronutrient to soil at different rates.

In some embodiments, the composition is configured to release at least one beneficial element to soil at different rates.

In some embodiments, the composition includes at most 20% by weight of tobermorite phase, and/or the composition includes at most 10% by weight of dicalcium silicate hydrate phase.

In some embodiments, the composition has a cation exchange ratio of at least 10 mmolc/kg.

In some embodiments, the composition has a cation exchange ratio of at most 500 mmolc/kg.

In some embodiments, the component includes KCl.

In some embodiments, the component includes at least one member selected from the group consisting of a macronutrient, a micronutrient and a beneficial element.

In some embodiments, the component includes at least one member selected from the group consisting of N, P, K, Ca, Mg, S, B, Cl, Cu, Fe, Mn, Mo, Ni, Zn, Na, Se, Si, Co and V.

### BRIEF DESCRIPTION OF THE FIGURES

The drawings are primarily for illustrative purposes and are not intended to limit the scope of the inventive subject matter described herein.

FIG. 1 schematically presents certain exemplary uses for, and benefits of, compositions disclosed herein.

FIG. 2 is a schematic representation of the process to produce a composition containing MPM and KCl, in different proportions. For the hydrothermal process (HYD), KCl is added to the feedstock mixture (potassic framework silicate ore and an oxide, a hydroxide and/or a carbonate of at least one of an alkaline earth metal and/or an alkali metal) and water mixture, as a powder, solution, or slurry, before the mixture undergoes hydrothermal processing. For the drying process (DRY), KCl is added to hydrothermally processed MPM precursor slurry, as a powder, liquid, or slurry, and is dried to a solid. For the powder process (PWD), KCl is physically mixed in as a solid with an MPM solid.

FIG. 3 is a representative SEM (scanning electron microscopy) image of drying process (DRY) mixture, showing KCl filling spaces within the MPM agglomerates, displaying high compatibility between MPM and KCl. Backscatter-electron (BSE) images were taken on a Phenom ProX desktop SEM with EDS (15 kV accelerating voltage, high vacuum) to confirm chemical composition of the phases in the field of view.

FIG. 4 is a representative SEM image showing the interaction between KCl and MPM particulates. This interaction between the KCl and MPM can aid in preventing the leaching losses of KCl because of MPM's capacity to adsorb cations (CEC). BSE images were taken on a Phenom ProX desktop SEM with EDS (15 kV accelerating voltage, high vacuum) to confirm chemical composition of the phases in the field of view.

FIG. 5 shows phase proportions and the mineralogical composition of the MPM:KCl mixtures, determined by powder X-ray diffraction (XRD). Both the hydrothermal process (HYD) and drying process (DRY) show underestimated sylvite (KCl) proportions due to inherent inhomogeneities in sampling from the post-processing and drying stages.

FIG. 6 shows diffraction patterns of MPM:KCl (DRY) compositions in a 1:1 mass ratio (1-MPM:1-KCl), KCl, as-prepared MPM (MPM—as-prepared), MPM rinsed with deionized water (MPM—DIW rinsed), MPM rinsed with 0.1 M citric acid (MPM—acid rinsed), and K-feldspar rich rock (Raw). Lines 1, 2, and 3 depict the presence or absence of representative diffraction peaks for tobermorite, microcline, and KCl, respectively.

FIG. 7 shows a schematic representation of the weight percent of K in a 1:1 mass ratio (1-MPM:1-KCl) composition. The columns represent total K, water-soluble K, and an aggregation of other types of K in the composition, respectively. K contents are numerically expressed in weight percentages.

FIG. 8 shows the volumetric PSD of a 1:1 mass ratio (1-MPM:1-KCl) composition (DRY) prepared using method 2 of FIG. 2 overlaid with the PSD of the starting material i.e., ultrapotassic K-feldspar rock powder. PSDs shown were obtained from laser diffraction measurements.

FIG. 9 shows a schematic representation of greenhouse protocol for testing the cumulative and residual effects of an MPM:KCl composition.

FIG. 10 shows a schematic representation of greenhouse protocol for testing the leaching losses of different compositions (MPM:KCl composition). DAE means days after emergence of green shoots.

FIG. 11 shows a schematic representation of greenhouse protocol for testing the efficacy of an MPM:KCl composition.

FIGS. 12A-C show greenhouse data for compositions for both the first and second cycles.

### DETAILED DESCRIPTION

The disclosure relates to compositions that include an MPM and at least one additional component, as well related methods of preparation and use. The properties of the compositions can be adjusted by modifying any of a number of processing parameters (including, but not limited to, processing time and temperature, drying conditions, processing atmosphere, ratio of raw materials in the feedstock mixture, surface area of the raw materials) such that the properties of the resulting composition can be adapted and aligned to suit the needs and/or desires of a wide variety of applications (e.g., agricultural, heavy metal contaminated soil remediation and other commercial and/or industrial). It should be appreciated that various concepts introduced above and discussed in greater detail below that are encompassed by the present disclosure may be implemented in any of numerous ways, as the disclosed concepts are not limited to any particular manner of implementation. Examples of specific implementations and applications are provided primarily for illustrative purposes.

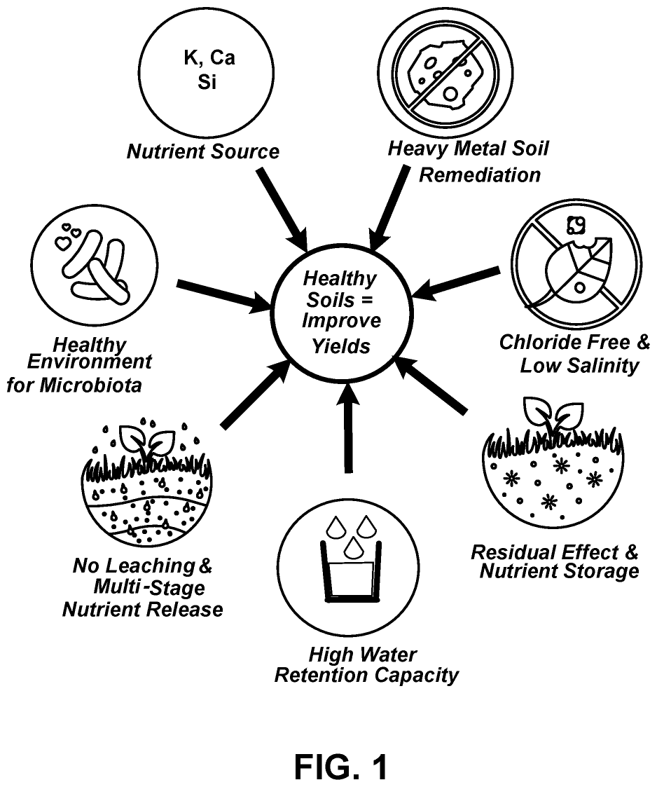

FIG. 1 schematically depicts representative uses for, and benefits of, compositions disclosed herein. In some embodiments, the compositions can be used as a nutrient source (e.g., as a source of K, Ca and/or Si). In some embodiments, the compositions can be used to provide a healthy environment for microbiota. In some embodiments, the compositions can be used to reduce nutrient leaching losses (e.g., K leaching) and/or for multi-stage nutrient release. In some embodiments, the compositions can be used to provide high water retention capacity. In some embodiments, the compositions have the effect of providing a residual effect to the soil and creating a nutrient storage. In some embodiments, the compositions are substantially chloride free and present low salinity. In some embodiments, the compositions can be used in heavy metal soil remediation. For example, in some embodiments, the compositions can be used to immobilize heavy metals from contaminated soil. Examples of heavy metals include cadmium (Cd), Arsenic (As) and lead (Pb). In some embodiments, the compositions disclosed herein can exhibit a combination of two or more of these properties.

Throughout this disclosure, there are places where reference is made to a composition that includes MPM and KCl (sylvite phase). It is to be understood that in such examples, instead of, or in addition to, KCl (sylvite phase), the composition may include one or more other additional components, such as, for example, one or more micronutrients (e.g., nitrogen (N), phosphorus (P), potassium (K), calcium (Ca), magnesium (Mg) and sulfur (S)), one or more micronutrients (e.g., boron (B), chlorine (Cl), copper (Cu), iron (Fe), manganese (Mn), molybdenum (Mo), nickel (Ni) and zinc (Zn)) and/or one or more other beneficial elements (e.g., sodium (Na), selenium (Se), silicon (Si), cobalt (Co) and vanadium (V).

In general, such an additional component can be introduced as part of any of the processes disclosed herein. As an example, in some embodiments, such an additional component is introduced via a source of the component in a manner similar to that described herein with respect to KCl. Generally, a source of an additional component can be used in any appropriate form. Examples of such forms include crystals, salts, powder, liquid (e.g., solution) and/or slurry. An exemplary and non-limiting list of source materials is as follows. Examples of phosphorus (P) sources include phosphate rock (e.g., raw material for phosphate fertilizer production), phosphoric acid (e.g., intermediate product from phosphate fertilizer production chain) and monoammonimum phosphate. Examples of nitrogen (N) sources include ammonia and urea. Examples of potassium (K) sources include KCl and sulphate of potash (SOP). Examples of magnesium (Mg) sources include magnesia and dolomitic lime. Examples of sulphur (S) sources include gypsum, sulphur and ammonium sulphate. Examples of calcium (Ca) sources includes gypsum and dolomitic lime. An example of a copper (Cu) source is copper sulphate. Examples of boron (B) sources include borates, borax and boric acid. An example of a zinc (Zn) source is zinc sulphate. An example of a manganese (Mn) source is manganese sulphate. Additional appropriate sources of these and other components are known.

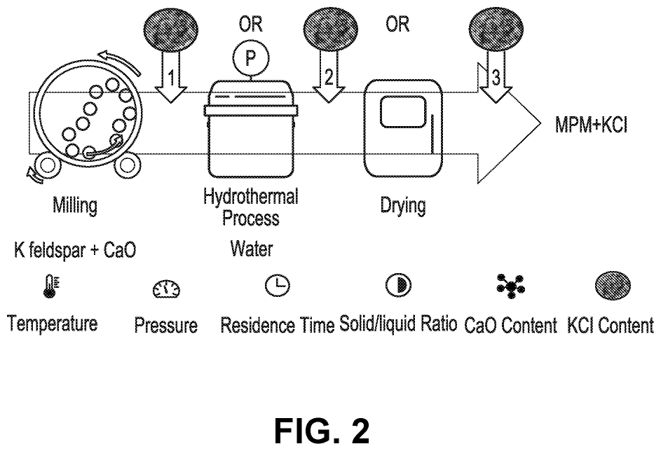

A flow chart providing an overview of certain embodiments of processes according to the present disclosure is provided in FIG. 2. Described in more detail below are various embodiments of the processes depicted in FIG. 2.

In some embodiments, the present disclosure provides a process of preparing a composition, wherein the process includes using as a starting material a mixture including particles of one or more potassic framework silicate and one or more compounds selected from an alkali metal oxide, an alkali metal hydroxide, an alkaline earth metal oxide, and alkaline earth metal hydroxide, and combinations thereof, followed by contact with water. This mixture is subjected to a temperature and pressure for a time sufficient to form intermediate material, in which the potassic framework silicate starting material is altered. The resulting material includes, for example, an intermediate slurry or powder or unaltered form of potassic framework silicate enriched with alkaline earth metal ions. As shown in method 2 in FIG. 2, in the next step, KCl is added (e.g., in an amount sufficient to the slurry with mixing until all KCl is dissolved) to form a mixed slurry or powder (e.g., in the desired weight ratio). Then, the slurry or powder is dried to form a composition including an MPM and KCl. The composition can provide both immediate release of K⁺ (e.g., from soluble portions of a composition) as well as extended release of potassium.

In various embodiments of the processes described herein, as shown in method 3 in FIG. 2, KCl is added and mixed as a powder to MPM, after the drying step.

In various embodiments of the processes described herein, as shown in method 1 in FIG. 2, KCl is added to the mixture of potassic framework silicate ore and an oxide, a hydroxide and/or a carbonate of at least one of an alkaline earth metal and an alkali metal and water before hydrothermally processing to form an intermediate slurry or powder, which is subsequently hydrothermally processed and dried to yield a composition which includes MPM and KCl.

In some embodiments, a process of making a composition that includes an MPM and KCl can involve two steps selected from method 1, method 2 and method 3 depicted in FIG. 2.

The altered intermediate formed, can be e.g., an altered form of potassic framework silicate (e.g., potassium feldspar (KAlSi₃O₈), leucite (KAlSi₂O₆), kalsilite (KAlSiO₄) and nepheline (Na₃KAl₄Si₄O₁₆), ultrapotassic syenite, or any of the other such materials disclosed herein) containing some amount of an alkali metal or alkaline earth metal exchanged from other materials (e.g., CaO, Ca(OH)₂, CaCO₃, and combinations thereof, etc. and/or KCl present in the mixture heated in the presence of water (optionally under pressure and/or modified atmosphere as described in various embodiments herein).

The methods disclosed herein can be carried out as a batch process or under continuous conditions. The step of forming a mixture of the particles as described herein above typically includes co-grinding or separately comminuting using methods known in the art, such as crushing, milling, etc. of dry or slurried materials, for example using jaw-crushers, gyratory crushers, cone crushers, ball mills, rod mills, etc. as described herein. The resulting mixture can be sized as desired, via sieves, screens, etc. known in the art. In some embodiments of the present methods, suitable mean particle sizes range from about 1 nm to about 2 mm. In some embodiments, the mean particle size is about 1 nm, about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 about 10 about 20 about 30 about 40 about 50 about 60 about 70 about 80 about 90 about 100 about 110 about 120 about 130 about 140 about 150 about 160 about 170 about 180 about 190 about 200 about 210 about 220 about 230 about 240 about 250 about 260 about 270 about 280 about 290 about 330 about 400 about 500 about 600 about 700 about 800 about 900 about 1 mm, about 2 mm, including all ranges and values there between. If desired, the materials can have similar particle sizes, or different particle sizes as described above.

In some embodiments of the present disclosure, the step (a) of forming a mixture is performed by milling (i.e., grinding, comminuting, pulverizing, etc.) the particles, either separately or together. In some embodiments, the unmilled particles are first combined and then subsequently milled to form the desired feed mixture (joint milling). In some embodiments, each of the materials is separately milled prior to combination of the materials. In some embodiments, only one is separately milled prior to combination of the materials, such that a milled material is combined with unmilled materials. In some embodiments of the present disclosure, the milling can be ball milling, fluid energy milling, wet milling, media milling, high pressure homogenization milling, cryogenic milling, rod milling, autogenous milling, semi-autonomous milling, buhrstone milling, vertical shaft impactor milling, tower milling, or any combination thereof.

Contacting the mixture with water can be carried out by any suitable method, such as adding water to the mixture, or by adding the mixture to water, or by sequentially or simultaneously adding the water and mixture to a suitable vessel, such as a reactor vessel in which the combination of water and the mixture can be heated to a temperature, optionally under a pressure and/or suitable atmosphere as described herein to form MPM. This process can be carried out in batch or continuous mode.

In some embodiments, the present disclosure provides a method of preparing MPM, which has improved release of K⁺ compared to the potassic framework silicate starting material from which it was prepared. In some embodiments of the present disclosure, the alkali metal silicate starting materials of the processes of the present disclosure are selected from a non-limiting group of materials including K-feldspar, kalsilite, nepheline, trachyte, rhyolite, ultrapotassic syenite, leucite, nepheline syenite, phonolite, fenite, aplite, pegmatite, and combinations thereof.

In some embodiments, the one or more compounds selected from an alkali metal oxide, an alkali metal hydroxide, an alkaline earth metal oxide, and alkaline earth metal hydroxide, and combinations thereof include calcium oxide, calcium hydroxide, or mixtures thereof. In some embodiments, the one or more compounds selected from an alkali metal oxide, an alkali metal hydroxide, an alkaline earth metal oxide, and alkaline earth metal hydroxide, and combinations thereof include calcium hydroxide. In some embodiments, the one or more compounds selected from an alkali metal oxide, an alkali metal hydroxide, an alkaline earth metal oxide, and alkaline earth metal hydroxide, and combinations thereof include calcium oxide. In certain embodiments, the one or more compounds selected from an alkali metal oxide, an alkali metal hydroxide, an alkaline earth metal oxide, and alkaline earth metal hydroxide, and combinations thereof include lithium oxide, sodium oxide, potassium oxide, rubidium oxide, cesium oxide, lithium hydroxide, sodium hydroxide, potassium hydroxide, rubidium hydroxide, and/or cesium hydroxide. In some embodiments, the one or more compounds selected from an alkali metal oxide, an alkali metal hydroxide, an alkaline earth metal oxide, and alkaline earth metal hydroxide, and combinations thereof include magnesium oxide, calcium oxide, beryllium oxide, strontium oxide, radium oxide, magnesium hydroxide, calcium hydroxide, beryllium hydroxide, strontium hydroxide, and/or radium hydroxide.

In some embodiments, the mixture includes a calcium-bearing compound and a silicon-bearing compound. In various embodiments of the present disclosure, the ratio of the calcium-containing material (i.e., CaO, CaOH, CaCO₃, (Ca,Mg)CO₃, and combinations thereof) to the silicon bearing material (i.e., potassium framework silicate) can be used to modulate the mineralogy, extraction, buffering capacity, as well as other properties of the composition (e.g., an MPM:KCl composition). In various embodiments, the Ca:Si molar ratio in the mixture is about 0.01 to 0.6. In some embodiments, the Ca:Si ratio is about 0.01, about 0.05, about 0.1, about 0.15, about 0.20, about 0.25, about 0.3, about 0.35, about 0.4, about 0.45, about 0.5, about 0.55, about 0.6, including all ranges and values there between.

In various embodiments of the method described herein, the mixture from step (a) is contacted with water. In some embodiments of the present disclosure, the process uses a weight excess of water relative to the potassic framework silicate starting material. In some embodiments of the present disclosure, the weight excess of water relative to the potassic framework silicate starting material as a weight ratio is about 0.1:1, about 0.2:1, about 0.3:1, about 0.4:1, about 0.5:1, about 0.6:1, about 0.7:1, about 0.8:1, about 0.9:1, about 1:1, about 2:1, about 3:1, 4:1, about 5:1, about 6:1, about 7:1, about 8:1, about 9:1, about 10:1, about 11:1, about 12:1, about 13:1, about 14:1, about 15:1, 1 about 6:1, about 17:1, about 18:1, about 19:1, and about 20:1.

In some embodiments, the milled feed mixture that is contacted with water is introduced into a hydrothermal processing apparatus, e.g., an autoclave, a pressurized agitation tank, a pipe reactor, a static mixer or other suitable container or reaction vessel known in the art for hydrothermal processing. In certain embodiments, reaction conditions such as mixing, atmosphere, time, temperature, and pressure can be modulated as a way to tune the properties of the product. In certain embodiments, modification of these parameters can be used to adjust the relative amounts of the constituent phases in the MPM, including but not limited to, amorphous phase, dicalcium silicate hydrate, hydrogarnet, tobermorite, and K-feldspar.

In various embodiments of the present disclosure, the method uses pressure ranges of from about 1-300 atm. In some embodiments, the method uses pressures of about 1 atm, about 10 atm, of about 20 atm, of about 30 atm, of about 40 atm, of about 50 atm, of about 60 atm, of about 70 atm, of about 80 atm, of about 90 atm, of about 100 atm, of about 110 atm, of about 120 atm, of about 130 atm, of about 140 atm, of about 150 atm, of about 160 atm, of about 170 atm, of about 180 atm, of about 190 atm, of about 200 atm, of about 210 atm, of about 220 atm, of about 230 atm, of about 240 atm, of about 250 atm, of about 260 atm, of about 270 atm, of about 280 atm, of about 290 atm, of about 300 atm, and any ranges of values between any of these values. In some embodiments of the present disclosure, the method uses temperature ranges of from about 90° C.-400° C. In some embodiments of the present disclosure, the method uses a temperature of about 90° C., about 100° C., about 110° C., about 120° C., about 130° C., about 140° C., about 150° C., about 160° C., about 170° C., about 180° C., about 190° C., about 200° C., about 210° C., about 220° C., about 230° C., about 240° C., about 250° C., about 260° C., about 270° C., about 280° C., about 290° C., about 300° C., about 310° C., about 320° C., about 330° C., about 340° C., about 350° C., about 360° C., about 370° C., about 380° C., about 390° C., about 400° C. and all ranges of values between any of these values. In some embodiments of the present disclosure, the duration of this step of the process ranges from about 0.01 to 6 h. In some embodiments of the present disclosure, the duration of this step of the process is about 0.01 h, about 0.02 h, about 0.03 h, about 0.04 h, about 0.05 h, about 0.06 h, about 0.07 h, about 0.08 h, about 0.09 h, about 0.1 h, about 0.2 h, about 0.3 h, about 0.4 h, about 0.5 h, about 0.6 h, about 0.7 h, about 0.8 h, about 0.9 h, about 1 h, about 2 h, about 3 h, about 4 h, about 5 h, about 6 h, and all ranges of values there between. In some embodiments of the present disclosure, the method uses atmospheric conditions that include, but are not limited to, argon (Ar), nitrogen (N₂), air, carbon dioxide (CO₂), or mixtures thereof.

In some embodiments of the present disclosure, the method includes a drying step. In some embodiments of the present disclosure, the drying step is carried out at a temperature of from about 100° C. to about 200° C. In some embodiments, the drying step can be carried out under reduced pressure conditions at temperatures ranging from 25° C. to about 200° C. In some embodiments of the present disclosure, the drying of the method is carried out at a temperature of about 25° C., about 30° C., about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., about 200° C., and all ranges between any of these values. In some embodiments, the drying step can be carried out under ambient temperatures, by simply allowing the supernatant water to evaporate. In some embodiments, the drying step can occur at any of the disclosed temperatures, with or without agitation, for a duration of about 0.01 to 48 h. In some embodiments, the drying step is carried out for a duration of about 0.01 h, about 0.02 h, about 0.03 h, about 0.04 h, about 0.05 h, about 0.06 h, about 0.07 h, about 0.08 h, about 0.09 h, about 0.1 h, about 0.2 h, about 0.3 h, about 0.4 h, about 0.5 h, about 0.6 h, about 0.7 h, about 0.8 h, about 0.9 h, about 1 h, about 2 h, about 3 h, about 4 h, about 5 h, about 6 h, about 7 h, about 8 h, about 9 h, about 10 h, about 11 h, about 12 h, about 13 h, about 14 h, about 15 h, about 16 h, about 17 h, about 18 h, about 19 h, or about 20 h, 21 h, about 22 h, about 23 h, about 24 h, about 25 h, about 26 h, about 27 h, about 28 h, about 29 h, about 30 h, about 31 h, about 32 h, about 33 h, about 34 h, about 35 h, about 36 h, about 37 h, about 38 h, about 39 h, or about 40 h including all ranges and values between any of these values.

In some embodiments of the present disclosure, the method includes carrying out the drying step, independently, under an inert or a reactive atmosphere. In some embodiments of the present disclosure, the inert atmosphere includes Ar or N₂, and the reactive atmosphere includes air, oxygen, carbon dioxide, carbon monoxide, or ammonia. In some embodiments of the present disclosure, this step of the process is carried out under an inert atmosphere including Ar, or a reactive atmosphere including air or carbon dioxide. In some embodiments of the present disclosure, this step of the process is carried out under an inert atmosphere including Ar, or a reactive atmosphere including air or carbon dioxide.

In some embodiments, a reactive atmosphere can include an inert gas such as Ar or N₂, provided that other gases in the atmosphere are reactive. For example, air is a mixture of N₂, which is generally inert, and oxygen, (as well as traces of CO₂) which is reactive. The term reactive atmosphere thus does not exclude gas compositions, which include inert gases, provided at least one of the gases in the atmosphere are reactive. The percentage of reactive gas as described herein in a reactive atmosphere is at least about 1%, but can be up to 100% (by volume), including about 1%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% by volume, including all ranges and subranges between any of these values. Any combination of reactive and inert gas described herein can be used. The conditions used for drying the altered intermediate material formed also influence the fundamental properties (e.g., mineralogy of the ultimate composition, including elemental extraction properties, porosity) of the solid.

In some embodiments of the present disclosure, the final composition is produced by granulation with a feed of MPM and at least one additional component (e.g., KCl).

In certain embodiments, the weight ratio of an MPM:KCl in the composition is at least 0.01:1 (e.g., at 0.05:1, at least 0.1:1, at least 0.2:1, at least 0.3:1, at least 0.4:1, at least 0.5:1, at least 0.6:1, at least 0.7:1, at least 0.8:1, at least 0.9:1) and at most 100:1 (e.g., at most 90:1, at most 80:1, at most 70:1, at most 60:1, at most 50:1, at most 40:1, at most 30:1, at most 20:1, at most 10:1, at most 1:1). In some embodiments the weight ratio of an MPM:KCl in the composition is between 0.01:1 and 100:1. In certain embodiments the weight ratio of the MPM:KCl in the composition is between 0.1:1 and 20:1.

In general, a composition may have a CEC as desired. For example, in some embodiments, a composition can have a CEC of at least 10 millimoles per kilogram (mmolc/kg) (e.g., at least 15 mmolc/kg, at least 20 mmolc/kg, at least 25 mmolc/kg, at least 30 mmolc/kg, at least 35 mmolc/kg, at least 40 mmolc/kg, at least 45 mmolc/kg, at least 50 mmolc/kg, at least 55 mmolc/kg, at least 60 mmolc/kg, at least 65 mmolc/kg, at least 70 mmolc/kg, at least 75 mmolc/kg, at least 80 mmolc/kg, at least 85 mmolc/kg, at least 90 mmolc/kg, at least 95 mmolc/kg, at least 100 mmolc/kg, at least 125 mmol/kg, at least 150 mmolc/kg, at least 175 mmol/kg, and/or at least 200 mmolc/kg) and/or at most 500 mmolc/kg (e.g., at most 450 mmolc/kg, at most 400 mmolc/kg, at most 350 mmolc/kg, at most 300 mmolc/kg, at most 250 mmolc/kg, at most 200 mmol/kg).

In various embodiments of the present disclosure, wherein KCl is added to a slurry of an MPM precursor, followed by drying to a powder, the MPM:KCl composition can include K-feldspar phase in a range of between 1% and 74.5% by weight, tobermorite phase in a range of between 0% and 55% by weight (e.g., between 0% and 50% by weight, between 0% and 45% by weight, between 0% and 40% by weight, between 0% and 35% by weight, between 0% and 30% by weight, between 0% and 25% by weight, between 0% and 20% by weight), hydrogrossular phase in a range of between 0% and 15% by weight (e.g., between 0% and 12% by weight), dicalcium silicate hydrate phase in a range of between 0% and 20% by weight (e.g., between 0% and 15% by weight, between 0% and 12% by weight, between 0% and 10% by weight), amorphous phase in a range of between 0% and 55% by weight (e.g., between 0% and 45% by weight), sylvite phase in a range of between 0.1% and 99% by weight and accessories phase in a range of between 0.1% and 20% by weight.

In some embodiments of the present disclosure, wherein KCl powder is physically mixed with an MPM powder, the MPM:KCl composition can include K-feldspar phase in a range of between 1% and 74.5% by weight, tobermorite phase in a range of 0% and 55% by weight (e.g., between 0% and 50% by weight, between 0% and 45% by weight, between 0% and 40% by weight, between 0% and 35% by weight, between 0% and 30% by weight, between 0% and 25% by weight, between 0% and 20% by weight), hydrogrossular phase in a range of between 0% and 15% by weight (e.g., between 0% and 12% by weight), dicalcium silicate hydrate phase in a range of between 0% and 20% by weight (e.g., between 0% and 15% by weight, between 0% and 12% by weight, between 0% and 10% by weight), amorphous phase in a range of between 0% and 55% by weight (e.g., between 0% and 45% by weight), sylvite phase in a range of between 0.1% and 99% by weight and accessories phase in a range of between 0.1% and 20% by weight.

In some embodiments of the present disclosure, KCl (e.g., as a powder, a solution, and/or a slurry) is added to the mixture of potassic framework silicate ore and an oxide, a hydroxide and/or a carbonate of at least one of an alkaline earth metal and an alkali metal and water, followed by hydrothermal processing and then drying, the MPM:KCl composition can include K-feldspar phase in a range of between 1% and 74.5% by weight, tobermorite phase in a range of 0% and 55% by weight (e.g., between 0% and 50% by weight, between 0% and 45% by weight, between 0% and 40% by weight, between 0% and 35% by weight, between 0% and 30% by weight, between 0% and 25% by weight, between 0% and 20% by weight), hydrogrossular phase in a range of between 0% and 15% by weight (e.g., between 0% and 12% by weight), dicalcium silicate hydrate phase in a range of between 0% and 20% by weight (e.g., between 0% and 15% by weight, between 0% and 12% by weight, between 0% and 10% by weight), amorphous phase in a range of between 0% and 55% by weight (e.g., between 0% and 45% by weight), sylvite phase in a range of between 0.1% and 99% by weight and accessories phase in a range of between 0.1% and 20% by weight.

In some embodiments of the present disclosure, the MPM:KCl composition can include K-feldspar phase in a range of between 1% and 74.5% by weight, tobermorite phase in a range of 0% and 55% by weight (e.g., between 0% and 50% by weight, between 0% and 45% by weight, between 0% and 40% by weight, between 0% and 35% by weight, between 0% and 30% by weight, between 0% and 25% by weight, between 0% and 20% by weight), hydrogrossular phase in a range of between 0% and 15% by weight (e.g., between 0% and 12% by weight), dicalcium silicate hydrate phase in a range of between 0% and 20% by weight (e.g., between 0% and 15% by weight, between 0% and 12% by weight, between 0% and 10% by weight), amorphous phase in a range of between 1% and 55% by weight (e.g., between 1% and 45% by weight), sylvite phase in a range of between 0.1% and 99% by weight and accessories phase in a range of between 0.1% and 20% by weight.

In certain embodiments, the MPM:KCl composition can include about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, about 31 wt. %, about 32 wt. %, about 33 wt. %, about 34 wt. % about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, about 50 wt. %, about 60 wt. %, about 70 wt. %, or about 74.5 wt. % of a K-feldspar phase, including all ranges and values there between.

In some embodiments, the MPM:KCl composition can include about 0 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. % of a tobermorite phase, including all ranges between any of these values.

In some embodiments, the MPM:KCl composition can include about 0 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. % hydrogrossular phase including all ranges between any of these values.

In some embodiments, the MPM:KCl composition can include about 0 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. % of a dicalcium silicate hydrate phase, including all ranges between any of these values.

In certain embodiments, the MPM:KCl composition can include about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, 17 wt. %, about 18 wt. %, about 20 wt. %, about 22 wt. %, about 24 wt. %, about 26 wt. %, about 28 wt. %, about 30 wt. %, about 32 wt. %, about 34 wt. %, about 36 wt. %, about 38 wt. %, about 40 wt. %, about 45 wt. %, about 50 wt. %, about 55 wt. % of an amorphous phase, including all ranges between any of these values.

In certain embodiments, the MPM:KCl composition can include about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1 wt. %, about 2 wt. %, about 3 wt. %, about 4 wt. %, about 5 wt. %, about 6 wt. %, %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, 17 wt. %, about 18 wt. %, about 20 wt. %, about 22 wt. %, about 24 wt. %, about 26 wt. %, about 28 wt. %, about 30 wt. %, about 32 wt. %, about 34 wt. %, about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, about 50 wt. %, about 60 wt. %, about 70 wt. %, about 80 wt. %, about 90 wt. %, about 99 wt. % of a sylvite phase, including all ranges between any of these values.

In certain embodiments, the MPM:KCl composition can include about 0.1 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, 17 wt. %, about 18 wt. %, about 19 wt. %, about 20 wt. %, of accessories phase, including all ranges between any of these values.

In certain embodiments, increasing the Ca:Si ratio in the feedstock drives product formation towards the formation of dicalcium silicate hydrate and/or amorphous phase. In certain embodiments, increasing the Ca:Si ratio in the feedstock has the concurrent effect of diminishing the tobermorite phase. In some embodiments, the dicalcium silicate hydrate phase can be obtained at higher levels than the tobermorite phase by increasing the Ca:Si ratio in the feed mixture. In various embodiments, the Ca:Si ratio is about 0.01 to 0.6. In certain embodiments, the Ca:Si ratio is about 0.01, about 0.02, about 0.03, about 0.04, about 0.05, about 0.05, about 0.06, about 0.07, about 0.08, about 0.09, about 0.1, about 0.125, about 0.150, about 0.175, about 0.2, about 0.225, about 0.250, about 0.275, about 0.3, about 0.325, about 0.350, about 0.375, about 0.4, about 0.425, about 0.450, about 0.475, about 0.5, about 0.525, about 0.550, about 0.575, about 0.6, including all ranges between any of these values.

In certain embodiments of the present process, the percentage of K⁺ in the MPM:KCl composition is in a range of between 1% and 59%.

In certain embodiments of the present process, the percentage of Cl⁻ in the in the MPM:KCl is in a range of between 0.5% and 48%.

In certain embodiments of the present process, the salinity index of MPM:KCl composition is in a range of between 5% and 130%.

In certain embodiments, the weight ratio of the MPM:KCl in the composition is at least 0.01:1 (e.g., at 0.05:1, at least 0.1:1, at least 0.2:1, at least 0.3:1, at least 0.4:1, at least 0.5:1, at least 0.6:1, at least 0.7:1, at least 0.8:1, at least 0.9:1) and/or at most 100:1 (e.g., at most 90:1, at most 80:1, at most 70:1, at most 60:1, at most 50:1, at most 40:1, at most 30:1, at most 20:1, at most 10:1, at most 1:1). In some embodiments the weight ratio of the MPM:KCl in the composition is between 0.01:1 and 100:1. In certain embodiments the weight ratio of the MPM:KCl in the composition is between 0.1:1 and 20:1.

In some embodiments of the present disclosure, the MPM:KCl composition is prepared by adding KCl to a MPM precursor slurry before drying to a powder, and the MPM:KCl composition includes K-feldspar phase in a range of between 14.5% and 74.5% by weight, tobermorite phase in a range of 0% and 55% by weight (e.g., between 0% and 50% by weight, between 0% and 45% by weight, between 0% and 40% by weight, between 0% and 35% by weight, between 0% and 30% by weight, between 0% and 25% by weight, between 0% and 20% by weight), hydrogrossular phase in a range of between 0% and 15% by weight (e.g., between 0% and 12% by weight), dicalcium silicate hydrate phase in a range of between 0% and 20% by weight (e.g., between 0% and 15% by weight, between 0% and 12% by weight, between 0% and 10% by weight), amorphous phase in a range of between 0% and 55% by weight (e.g., between 0% and 45% by weight), sylvite phase in a range of between 0.99% and 50% by weight and accessories phase in a range of between 0.1% and 20% by weight.

In some embodiments of the present disclosure, the MPM:KCl composition is prepared by physically mixing KCl powder with an MPM powder after the drying step, and the MPM:KCl composition includes K-feldspar phase in a range of between 14.5% and 74.5% by weight, tobermorite phase in a range of 0% and 55% by weight (e.g., between 0% and 50% by weight, between 0% and 45% by weight, between 0% and 40% by weight, between 0% and 35% by weight, between 0% and 30% by weight, between 0% and 25% by weight, between 0% and 20% by weight), hydrogrossular phase in a range of between 0% and 15% by weight (e.g., between 0% and 12% by weight), dicalcium silicate hydrate phase in a range of between 0% and 20% by weight (e.g., between 0% and 15% by weight, between 0% and 12% by weight, between 0% and 10% by weight), amorphous phase in a range of between 0% and 55% by weight (e.g., between 0% and 45% by weight), sylvite phase in a range of between 0.99% and 50% by weight and accessories phase in a range of between 0.1% and 20% by weight.

In some embodiments of the present disclosure, the MPM:KCl composition is prepared by adding KCl (e.g., as a powder, a solution, and/or a slurry) to a mixture of potassic framework silicate ore and an oxide, a hydroxide and/or a carbonate of at least one of an alkaline earth metal and an alkali metal and water before hydrothermal processing and subsequent drying, and the MPM:KCl composition includes K-feldspar phase in a range of between 14.5% and 74.5% by weight, tobermorite phase in a range of between 0% and 55% by weight (e.g., between 0% and 50% by weight, between 0% and 45% by weight, between 0% and 40% by weight, between 0% and 35% by weight, between 0% and 30% by weight, between 0% and 25% by weight, between 0% and 20% by weight), hydrogrossular phase in a range of between 0% and 15% by weight (e.g., between 0% and 12% by weight), dicalcium silicate hydrate phase in a range of between 0% and 20% by weight (e.g., between 0% and 15% by weight, between 0% and 12% by weight, between 0% and 10% by weight), amorphous phase in a range of between 1% and 55% by weight (e.g., between 1% and 45% by weight), sylvite phase in a range of between 0.99% and 50% by weight and accessories phase in a range of between 0.1% and 20% by weight.

In some embodiments of the present disclosure, the MPM:KCl composition can include K-feldspar phase in a range of between 14.5% and 74.5% by weight, tobermorite phase in a range of 0% and 55% by weight (e.g., between 0% and 50% by weight, between 0% and 45% by weight, between 0% and 40% by weight, between 0% and 35% by weight, between 0% and 30% by weight, between 0% and 25% by weight, between 0% and 20% by weight), hydrogrossular phase in a range of between 0% and 15% by weight (e.g., between 0% and 12% by weight), dicalcium silicate hydrate phase in a range of between 0% and 20% by weight (e.g., between 0% and 15% by weight, between 0% and 12% by weight, between 0% and 10% by weight), amorphous phase in a range of between 1% and 55% by weight (e.g., between 1% and 45% by weight), sylvite phase in a range of between 0.99% and 50% by weight and accessories phase in a range of between 0.1% and 20% by weight.

In some embodiments, the MPM:KCl composition can include at least about 1 wt. % K-feldspar phase. In certain embodiments, the MPM:KCl composition can include about 14.5 wt. %, at most about 14.5 wt. %, about 15 wt. %, at most about 15 wt. %, about 20 wt. %, at most about 20 wt. %, about 25 wt. %, at most about 25 wt. %, about 30 wt. %, at most about 30 wt. %, about 35 wt. %, at most about 35 wt. %, about 40 wt. %, at most about 40 wt. %, about 45 wt. %, at most about 45 wt. %, about 50 wt. %, at most about 50 wt. %, about 55 wt. %, at most about 55 wt. %, about 60 wt. %, at most about 60 wt. %, about 64 wt. %, at most about 64 wt. %, about 70 wt. %, at most about 70 wt. %, at most about 74.5 wt. % of a K-feldspar phase, including all ranges and values there between.

In some embodiments, the MPM:KCl composition can include about 0 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. % of a tobermorite phase, including all ranges between any of these values.

In some embodiments, the MPM:KCl composition can include about 0 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. % 15 wt. % of a hydrogrossular phase including all ranges between any of these values.

In some embodiments, the MPM:KCl composition can include about 0 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, 20 wt. % of a dicalcium silicate hydrate phase, including all ranges between any of these values.

In some embodiments, the MPM:KCl composition can include about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, 17 wt. %, about 18 wt. %, about 20 wt. %, about 22 wt. %, about 24 wt. %, about 26 wt. %, about 28 wt. %, about 30 wt. %, about 32 wt. %, about 34 wt. %, about 36 wt. %, about 38 wt. %, about 40 wt. %, about 45 wt. %, about 50 wt. %, about 55 wt. % of an amorphous phase, including all ranges between any of these values.

In some embodiments, the MPM:KCl composition can include about 0.99 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1 wt. %, about 2 wt. %, about 3 wt. %, about 4 wt. %, about 5 wt. %, about 6 wt. %, %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, 17 wt. %, about 18 wt. %, about 20 wt. %, about 22 wt. %, about 24 wt. %, about 26 wt. %, about 28 wt. %, about 30 wt. %, about 32 wt. %, about 34 wt. %, about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, about 50 wt. %, of a sylvite phase, including all ranges between any of these values.

In some embodiments, the MPM:KCl composition can include about 0.1 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, 17 wt. %, about 18 wt. %, about 19 wt. %, about 20 wt. %, of accessories phase, including all ranges between any of these values.

In some embodiments, a method includes using a Ca:Si ratio of about 0.01 to 0.6. In certain embodiments, the Ca:Si ratio is about 0.01, about 0.02, about 0.03, about 0.04, about 0.05, about 0.05, about 0.06, about 0.07, about 0.08, about 0.09, about 0.1, about 0.125, about 0.150, about 0.175, about 0.2, about 0.225, about 0.250, about 0.275, about 0.3, about 0.325, about 0.350, about 0.375, about 0.4, about 0.425, about 0.450, about 0.475, about 0.5, about 0.525, about 0.550, about 0.575, about 0.6, including all ranges between any of these values.

In some embodiments, the percentage of K⁺ in the MPM:KCl composition is in a range of between 8% and 31%.

In some embodiments, the percentage of Cl⁻ in the in the MPM:KCl composition is in a range of between 7% and 29%.

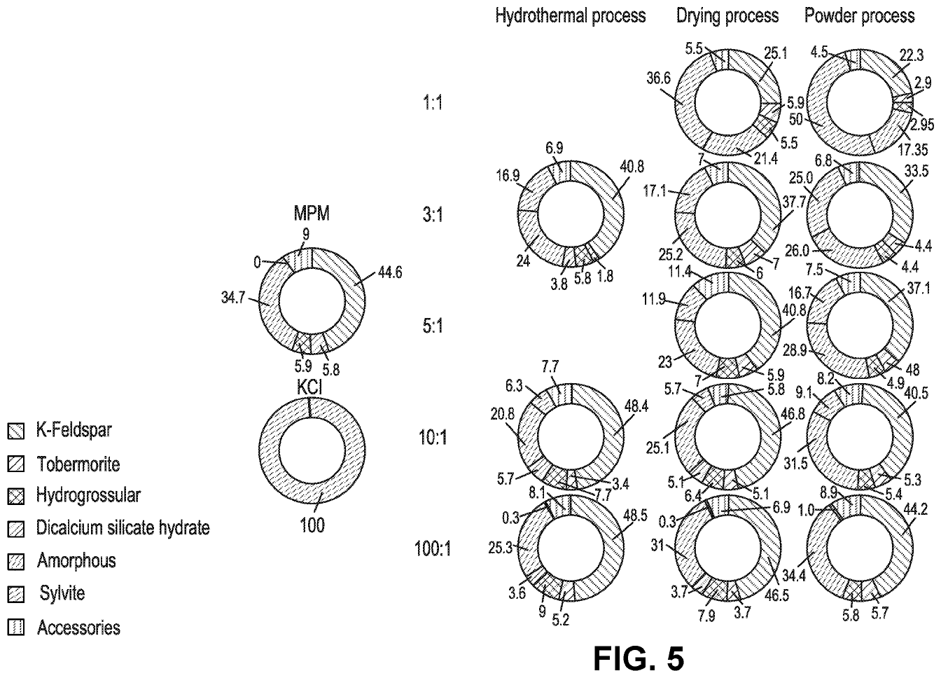

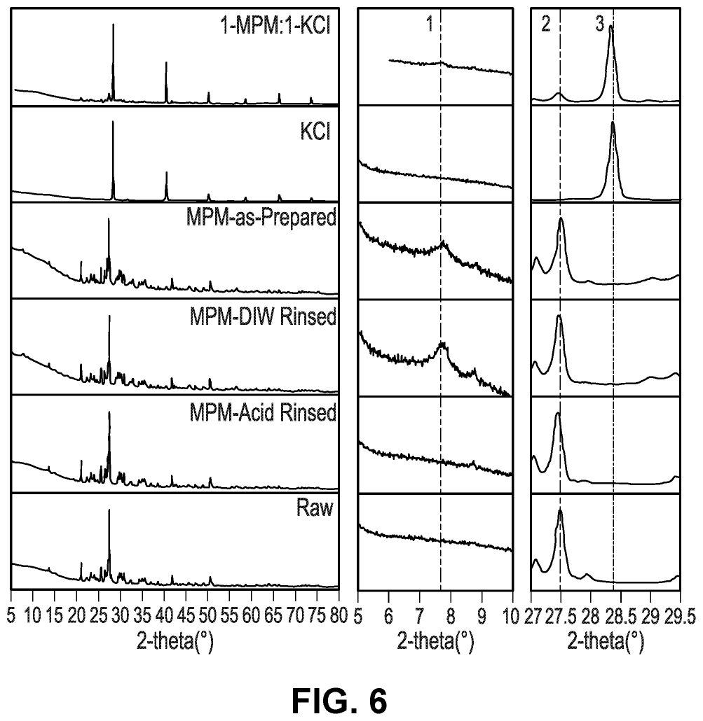

Many of the compositions disclosed herein have been, or can be, characterized by X-Ray Powder Diffraction (XRPD), Scanning Electron Microscopy (SEM), and chemical extractions (as well as other techniques known to the skilled artisan), which confirmed, or can confirm, that the composition does in fact possess the above-mentioned desirable properties. An understanding of the mineralogy of the compositions has been gained from XRPD results (FIG. 6) and imaging (FIGS. 4 and 5), such that the mineral phases composing the MPM:KCl composition can be identified and quantified, as well as their degree of elemental inclusions with respect to stoichiometric chemical formulae.

From the characterization, it was found that a composition can exhibit complex mineralogy and chemical properties. The disclosed compositions have mean particle size range from about 1 nm to about 5 mm. In certain embodiments, the mean particle size is about is about 1 nm, about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 about 10 about 20 about 30 about 40 about 50 about 60 about 70 about 80 about 90 about 100 about 110 about 120 about 130 about 140 about 150 about 160 about 170 about 180 about 190 about 200 about 210 about 220 about 230 about 240 about 250 about 260 about 270 about 280 about 290 about 300 about 400 about 500 about 600 about 700 about 800 about 900 about 1 mm, about 2 mm, about 3 mm, about 4 mm, or about 5 mm, including all ranges between any of these values.

Herein, it is recognized that the mineralogy (along with other features) of an MPM can be modified to optimize the nutrient-release characteristics of the composition (e.g., an MPM:KCl composition) to meet the needs or desires of a variety of soils, along with other industrial applications. Chemical composition analysis from chemical extractions were correlated with XRPD analyses to assess the chemical stability of the phases in the composition (e.g., an MPM:KCl composition—FIG. 6). The percentage of mass lost from various extractants are shown in Table 1 to elucidate the various types of K present in an embodiment of the disclosed disclosure. Notably, chemical stability is related to the ability for fertilizers or soil amendments to release plant nutrients, and should be contextualized in an agronomic context.

TABLE 1
Percentage of mass lost from extraction procedure

Extractant

| Sample | DI water | Citric acid |
|---|---|---|
| MPM | 6% | 66% |
| 1-MPM:1-KCl | 52% | 85% |

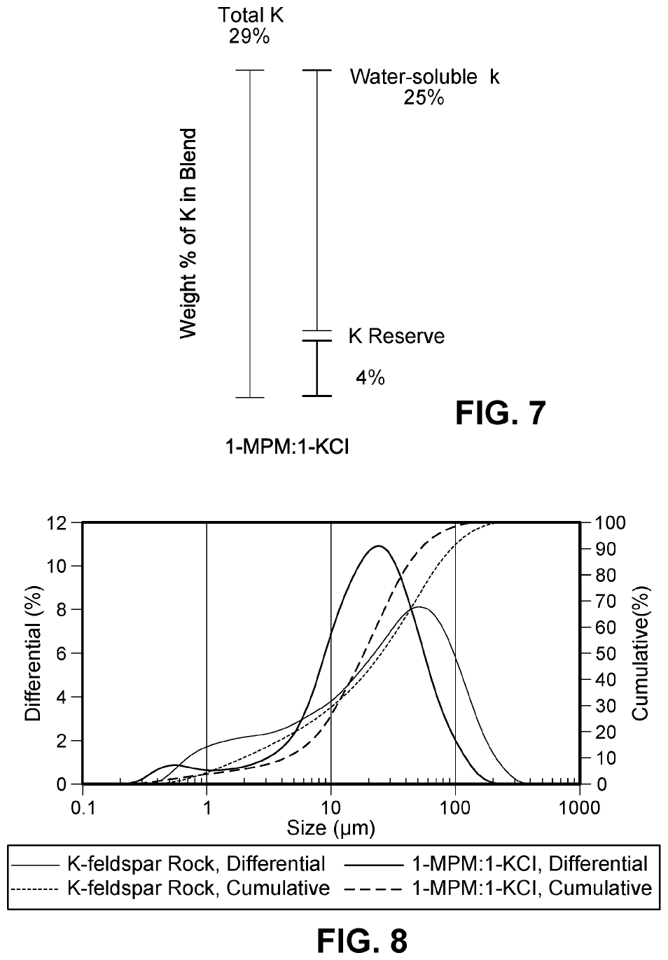

As described in detail throughout this disclosure and in the Examples that follow, a prominent feature of the MPM:KCl composition is the availability of potassium (K), as evidenced by a water-solubility test (FIG. 7). Moreover, the nature (e.g., rate and pattern) of the release is in contrast to the purely water-soluble-K-containing KCl-fertilizers that dissolve rapidly and result in a sudden increase of local K⁺ and Cl⁻ concentrations, which in turn drastically perturbs the equilibria between exchangeable and non-exchangeable K. Furthermore, in KCl the major fraction of K is lost by leaching, a phenomenon that proceeds at a relatively slow rate in temperate soils, but is exacerbated and accelerated in tropical soils.

In some embodiments, the presently disclosed processes are used to prepare a MPM:KCl composition that releases K⁺ and the amount of K⁺ released from the alkali metal releasing composition after 30 minute (min) exposure to a 100-fold excess of 0.1 M citric acid is at least 676-fold higher than the amount of K⁺ released by the one or more potassic framework silicate starting materials under the same extraction conditions.

In some embodiments of the present disclosure, the amount of K⁺ released from the MPM:KCl composition after 30 min exposure to a 100-fold excess of 0.1 M citric acid relative to the amount of K⁺ released by the one or potassic framework silicate starting materials under the same extraction conditions is 2-fold higher, 3-fold higher, 4-fold higher, 5-fold higher, 6-fold higher, 7-fold higher, 8-fold higher, 9-fold higher, 10-fold higher, 15-fold higher, 20-fold higher, 25-fold higher, 30-fold higher, 35-fold higher, 40-fold higher, 45-fold higher, 50-fold higher, 55-fold higher, 60-fold higher, 65-fold higher, 110-fold higher, 155-fold higher, 201-fold higher, 246-fold higher, 291-fold higher, 337-fold higher, 382-fold higher, 427-fold higher, 473-fold higher, 518-fold higher, 563-fold higher, 608-fold higher, 654-fold higher, 699-fold higher, 744-fold higher, 790-fold higher, 835-fold higher, 880-fold higher, 925-fold higher, 971-fold higher, 1016-fold higher, 1061-fold higher, 1107-fold higher, 1152-fold higher, 1197-fold higher, 1243-fold higher, or 1288-fold higher, including all values there between.

In some embodiments, the MPM:KCl composition releases K⁺ and the amount of K⁺ released from the alkali metal releasing composition after 30 min exposure to a 100-fold excess of deionized water is at least 2650-fold higher than the amount of K⁺ released by the one or more potassic framework silicate starting materials under the same extraction conditions.

In some embodiments of the present disclosure, the amount of K⁺ released from the MPM:KCl composition after 30 min exposure to a 100-fold excess of deionized water relative to the amount of K⁺ released by the one or potassic framework silicate starting materials under the same extraction conditions is 2-fold higher, 3-fold higher, 4-fold higher, 5-fold higher, 6-fold higher, 7-fold higher, 8-fold higher, 9-fold higher, 10-fold higher, 15-fold higher, 20-fold higher, 25-fold higher, 30-fold higher, 35-fold higher, 40-fold higher, 45-fold higher, 50-fold higher, 55-fold higher, 60-fold higher, 70-fold higher, 80-fold higher, 90-fold higher, 100-fold higher, 150-fold higher, 336-fold higher, 521-fold higher, 706-fold higher, 891-fold higher, 1076-fold higher, 1262-fold higher, 1447-fold higher, 1632-fold higher, 1817-fold higher, 2002-fold higher, 2188-fold higher, 2373-fold higher, 2558-fold higher, 2743-fold higher, 2928-fold higher, 3113-fold higher, 3299-fold higher, 3484-fold higher, 3669-fold higher, 3854-fold higher, 4039-fold higher, 4225-fold higher, 4410-fold higher, 4595-fold higher, 4780-fold higher, 4965-fold higher, or 5150-fold higher, including all values there between.

In some embodiments of the present disclosure, the methods provide an MPM:KCl composition, wherein the amount of K⁺ released from the MPM:KCl composition after 30 min exposure to a 100-fold excess of 0.1 M citric acid ranges from about 5 to about 260 g K⁺/kg MPM:KCl composition.

In certain embodiments, the amount of K⁺ released was about 0.4 g K⁺/kg MPM:KCl composition, about 1 g K⁺/kg MPM:KCl composition, about 5 g K⁺/kg MPM:KCl composition, about 10 g K⁺/kg MPM:KCl composition, about 25 g K⁺/kg MPM:KCl composition, about 50 g K⁺/kg MPM:KCl composition, about 100 g K⁺/kg MPM:KCl composition, about 130 g K⁺/kg MPM:KCl composition, about 160 g K⁺/kg MPM:KCl composition, about 190 g K⁺/kg MPM:KCl composition, about 210 g K⁺/kg MPM:KCl composition, about 240 g K⁺/kg MPM:KCl composition, about 270 g K⁺/kg MPM:KCl composition, about 300 g K⁺/kg MPM:KCl composition, about 400 g K⁺/kg MPM:KCl composition, about 500 g K⁺/kg MPM:KCl composition, about 520 g K⁺/kg MPM:KCl composition, including all values and ranges there between.

In some embodiments of the present disclosure, the methods provide an MPM:KCl composition, wherein the amount of K⁺ released from the MPM:KCl composition after 30 min exposure to a 100-fold excess of deionized ranges from about 5 to about 271 g K⁺/kg MPM:KCl composition.

In certain embodiments, the amount of K⁺ released was about 0.2 g K⁺/kg MPM:KCl composition, about 0.4 g K⁺/kg MPM:KCl composition, about 1 g K⁺/kg MPM:KCl composition, about 5 g K⁺/kg MPM:KCl composition, about 10 g K⁺/kg MPM:KCl composition, about 25 g K⁺/kg MPM:KCl composition, about 50 g K⁺/kg MPM:KCl composition, about 100 g K⁺/kg MPM:KCl composition, about 130 g K⁺/kg MPM:KCl composition, about 160 g K⁺/kg MPM:KCl composition, about 190 g K⁺/kg MPM:KCl composition, about 210 g K⁺/kg MPM:KCl composition, about 240 g K⁺/kg MPM:KCl composition, about 270 g K⁺/kg MPM:KCl composition, about 300 g K⁺/kg MPM:KCl composition, about 400 g K⁺/kg MPM:KCl composition, about 500 g K⁺/kg MPM:KCl composition, about 520 g K⁺/kg MPM:KCl composition, including all values and ranges there between.

In some embodiments of the present disclosure, the MPM:KCl composition as described herein possesses a rhizosphere-responsive K release, wherein one portion of K⁺ is water-soluble salt, while an additional portions are released over an extended period of time. Therefore, in some embodiments, the MPM:KCl composition disclosed herein possess the desirable property of having both fast-release K and slow-release K. In various embodiments of the present disclosure, the ratio of immediate-release (soluble) K to slow (solid phase) K in the MPM:KCl composition is from about 720:1 to about 0.01:1. In some embodiments, the ratio is about 720:1, about 700:1, about 600:1, about 500:1, about 400:1, about 300:1, about 200:1, about 100:1, about 50:1, about 10:1, about 9:1, about 8:1, about 7:1, about 6:1, about 5:1, about 4:1, about 3:1, about 2:1, about 1:1, about 0.8:1, about 0.6:1, about 0.4:1, about 0.2:1, about 0.1:1, or about 0.01:1 including all ranges and values there between.

In some embodiments of the present disclosure, the MPM:KCl composition as described herein possesses a ratio of immediate-release (soluble) K to slow (solid phase) K from about 8:1 to about 0.1:1. In some embodiments, the ratio is about 20:1, about 10:1, 8:1, about 7:1, about 6:1, about 5:1, about 4:1, about 3:1, about 2:1, about 1:1, about 0.8:1, about 0.6:1, about 0.4:1, about 0.2:1, about 0.1:1, or about 0.01:1 including all ranges and values there between.

In some embodiments of the present disclosure, the MPM:KCl composition can possess an immediately soluble carbonaceous constituent that provides crops an immediate source of chlorine-free K. However, in contrast to KCl and similar materials, the present disclosure also provides embodiments where the small, yet useful portion of K released from the MPM:KCl composition can be distributed among several phases, and thus K is likely to be available at a slower rate.

In various embodiments of the present disclosure, the MPM:KCl composition provided by the disclosed methods is a fertilizer. In some embodiments of the present disclosure, the fertilizer is a K⁺ fertilizer. In some embodiments of the present disclosure, the fertilizer is a multi-nutrient fertilizer.

In some embodiments of the present disclosure, the MPM:KCl compositions contain K-feldspar phase in a range of between 1% and 74.5% by weight, tobermorite phase in a range of between 0% and 55% by weight (e.g., between 0% and 50% by weight, between 0% and 45% by weight, between 0% and 40% by weight, between 0% and 35% by weight, between 0% and 30% by weight, between 0% and 25% by weight, between 0% and 20% by weight), hydrogrossular phase in a range of between 0% and 15% by weight (e.g., between 0% and 12% by weight), dicalcium silicate hydrate phase in a range of between 0% and 20% by weight (e.g., between 0% and 15% by weight, between 0% and 12% by weight, between 0% and 10% by weight), amorphous phase in a range of between 1% and 55% by weight (e.g., between 1% and 45% by weight), sylvite phase in a range of between 0.1% and 99% by weight and accessories phase in a range of between 0.1% and 20% by weight.

In some embodiments, the compositions of MPM:KCl include about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, 20 wt. %, about 21 wt. %, about 22 wt. %, about 23 wt. %, about 24 wt. %, about 25 wt. % of a K-feldspar phase, about 26 wt. %, about 27 wt. %, about 28 wt. %, about 29 wt. %, about 30 wt. %, about 31 wt. %, about 32 wt. %, about 33 wt. %, about 34 wt. % about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, about 50 wt. %, about 60 wt. %, about 70 wt. %, or about 74.5 wt. % of a K-feldspar phase, including all ranges and values there between.

In some embodiments, compositions of MPM:KCl include about 1.5 wt. %, about 1.6 wt. %, about 1.7 wt. %, about 1.8 wt. %, about 1.9 wt. %, about 2 wt. %, about 3 wt. %, about 4 wt. %, about 5 wt. %, about 6 wt. %, about 7 wt. %, about 8 wt. %, about 9 wt. %, about 10 wt. %, about 15 wt. %, about 20 wt. %, about 25 wt. %, about 30 wt. %, about 35 wt. % of, about 40 wt. %, about 45 wt. %, about 50 wt. %, about 55 wt. % of a tobermorite phase, including all ranges between any of these values.

In some embodiments, the compositions of MPM:KCl include about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. % of a hydrogrossular phase including all ranges between any of these values.

In some embodiments, the compositions of MPM:KCl composition include about 0 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. % or about 20 wt. % of a dicalcium silicate hydrate phase, including all ranges between any of these values.

In some embodiments, the compositions of MPM:KCl include about 1 wt. %, about 5 wt. %, about 10 wt. %, about 15 wt. %, about 20 wt. %, about 25 wt. %, about 30 wt. %, about 35 wt. %, about 40 wt. %, or about 45 wt. %, about 50 wt. % or about 55 wt. % (e.g., between 0% and 45% by weight) of an amorphous phase, including all ranges between any of these values.

In some embodiments, the compositions of MPM:KCl include about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1 wt. %, about 2 wt. %, about 3 wt. %, about 4 wt. %, about 5 wt. %, about 6 wt. %, %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, 17 wt. %, about 18 wt. %, about 20 wt. %, about 22 wt. %, about 24 wt. %, about 26 wt. %, about 28 wt. %, about 30 wt. %, about 32 wt. %, about 34 wt. %, about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, about 50 wt. %, about 60 wt. %, about 70 wt. %, about 80 wt. %, about 90 wt. %, about 99 wt. % of a sylvite phase, including all ranges between any of these values.

In some embodiments, the compositions of MPM:KCl include about 0.1 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, 17 wt. %, about 18 wt. %, about 19 wt. %, about 20 wt. % of accessories phase, including all ranges between any of these values.

In some embodiments of the present disclosure, compositions of MPM:KCl include K-feldspar phase in a range of between 14.5% and 74.5% by weight, tobermorite phase in a range of between 0% and 55% by weight (e.g., between 0% and 50% by weight, between 0% and 45% by weight, between 0% and 40% by weight, between 0% and 35% by weight, between 0% and 30% by weight, between 0% and 25% by weight, between 0% and 20% by weight), hydrogrossular phase in a range of between 0% and 15% by weight (e.g., between 0% and 12% by weight), dicalcium silicate hydrate phase in a range of between 0% and 20% by weight (e.g., between 0% and 15% by weight, between 0% and 12% by weight, between 0% and 10% by weight), amorphous phase in a range of between 1% and 55% by weight (e.g., between 1% and 45% by weight), sylvite phase in a range of between 0.99% and 50% by weight and accessories phase in a range of between 0.1% and 20% by weight.

In some embodiments, the compositions of MPM:KCl include about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, 20 wt. %, about 21 wt. %, about 22 wt. %, about 23 wt. %, about 24 wt. %, about 25 wt. % of a K-feldspar phase, about 26 wt. %, about 27 wt. %, about 28 wt. %, about 29 wt. %, about 30 wt. %, about 31 wt. %, about 32 wt. %, about 33 wt. %, about 34 wt. % about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, about 50 wt. %, about 60 wt. %, about 70 wt. %, or about 74.5 wt. % of a K-feldspar phase, including all ranges and values there between.

In some embodiments, compositions of MPM:KCl composition include about 1.5 wt. %, about 1.6 wt. %, about 1.7 wt. %, about 1.8 wt. %, about 1.9 wt. %, about 2 wt. %, about 3 wt. %, about 4 wt. %, about 5 wt. %, about 6 wt. %, about 7 wt. %, about 8 wt. %, about 9 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. % of a tobermorite phase, including all ranges between any of these values.

In some embodiments, the compositions of MPM:KCl include about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. % or about 15 wt. % of a hydrogrossular phase including all ranges between any of these values.

In some embodiments, the compositions of MPM:KCl include about 0 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. % or about 20 wt. % of a dicalcium silicate hydrate phase, including all ranges between any of these values.

In some embodiments, the compositions of MPM:KCl composition include about 17 wt. %, about 18 wt. %, about 20 wt. %, about 22 wt. %, about 24 wt. %, about 26 wt. %, about 28 wt. %, about 30 wt. %, about 32 wt. %, about 34 wt. %, about 36 wt. %, about 38 wt. %, about 40 wt. %, or about 45 wt. %, about 50 wt. % or about 55 wt. % of an amorphous phase, including all ranges between any of these values.

In some embodiments, the compositions of MPM:KCl composition include about 0.9 wt. %, about 1 wt. %, about 2 wt. %, about 3 wt. %, about 4 wt. %, about 5 wt. %, about 6 wt. %, %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, 17 wt. %, about 18 wt. %, about 20 wt. %, about 22 wt. %, about 24 wt. %, about 26 wt. %, about 28 wt. %, about 30 wt. %, about 32 wt. %, about 34 wt. %, about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, about 50 wt. %, of a sylvite phase, including all ranges between any of these values.

In some embodiments, the compositions of MPM:KCl composition include about 0.1 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, 17 wt. %, about 18 wt. %, about 19 wt. %, about 20 wt. % of accessories phase, including all ranges between any of these values.

In some embodiments, the compositions disclosed herein further include one or more carbonates selected from the group including K₂CO₃, Na₂CO₃, MgCO₃, and CaCO₃ and combinations thereof.

In various embodiments of the disclosure, the processes for the preparation of K-source compositions demonstrate the potential application in agriculture (e.g., as a K-fertilizer) and/or in soil remediation (e.g., by immobilizing heavy metals from the soil). For example, the present disclosure is directed to a new process for the preparation of such compositions, which would significantly reduce the salinity of the soil, compared with KCl fertilizers. In addition, but are not limited to, the present disclosure creates new compositions with different rates of K-release and combines the very high solubility of potassium chloride with the multi-stage K-release, high adsorption capacity, high residual effect, the ability to buffer soil pH at optimal levels for a given crop and microbiome, and minimal salinity of hydrothermally processed potassium.

The analysis of the MPM:KCl composition that follows provides new insights on the process described herein and their application in agriculture. The overall discussion is framed according to the overarching goal of engineering a process scalable to industrial outputs that can truly benefit nutrient-poor and scarcely productive soils. These compositions are able to supply nutrients to the crops for the entire season through a single application, thereby saving on application costs and reducing the demand for short-season manual labor, in addition to improving agronomic performance through reduction of stress and specific toxicity resulting from intense and excessive nutrient supply to the root zones (and germinating seeds). It has been unexpectedly discovered that the composition (i.e., mineralogy) and extraction properties of the MPM:KCl composition as disclosed herein can be tuned through alterations of the processing conditions. The examples that follow offer support for this finding while emphasizing that the MPM:KCl composition disclosed herein is adaptable to a number of important applications.

### EXAMPLES

A schematic flow chart of the batch processing route is provided in FIG. 2. The steps of the process include a potassic framework silicate ore hydrothermal processed with an oxide, a hydroxide and a carbonate of at least one of an alkaline earth metal and an alkali metal and water at a temperature of between 90° C. and 400° C., to a pressure of between 1 to 300 atm for 0.01 to 6 h to form a MPM slurry; and a second step of introducing KCl, in an amount sufficient to the slurry with mixing until all KCl is dissolved, to form a mixed KCl and MPM precursor slurry or powder in the desired weight ratio; and a third step of drying at a temperature of between 90° C. and 200° C. (e.g., 100° C. and 200° C.), to a pressure of between 1 to 100 atm for 0.01 to 48 h. Also, the KCl can be, optionally, added and mixed as a powder to MPM, after drying step at a temperature of between 90° C. and 200° C. (e.g., 100° C. and 200° C.), to a pressure of between 1 to 100 atm for 0.01 to 48 h or added to the mixture of potassic framework silicate ore and an oxide, a hydroxide and/or a carbonate of at least one of an alkaline earth metal and an alkali metal and water before hydrothermal processing to form a MPM:KCl slurry.

### Example 1: Synthesis and Characterization of Reagents and K-Source Compositions

The ultrapotassic syenite used herein was obtained from the Triunfo batholith, located in Pernambuco State, Brazil. The K-feldspar content was 94.5 wt. %. Hand-sized field samples were comminuted in a jaw crusher, and sieved to obtain particles with size <2 mm. Calcium oxide (CaO), reagent grade (Fisher Scientific) was used as received.

The feed mixture for hydrothermal processing was obtained by dry milling ultrapotassic syenite (<2 mm), down to a P90 ˜150 CaO is added to the K-feldspar rich powder to achieve a nominal Ca:Si molar ratio of 0.3, based on the assumption that there was no Si in the CaO and no Ca in the ultrapotassic syenite.

The hydrothermal processing, MPM:KCl mixing, and product recovery followed method 2 of FIG. 2. A 5-gallon autoclave was loaded with 3.2 kg of feed mixture and 9.6 kg of water. The reactor was sealed and the rotation of the impellor set at 300 rpm. The temperature set point of 220° C. was reached in 2 h. The internal pressure of the reactor was about 23 barg. Subsequently, the reactor was cooled down with an internal water-cooling system, until the internal T reached ˜40° C. The reactor was opened quickly, and the MPM slurry transferred quantitatively in a 5-gallon plastic bucket. The desired amount of KCl (e.g., 1-weight equivalent) was mixed into the slurry and homogenized using a power drill adapted with a cement mixer. The slurry was then transferred into autoclavable plastic trays and dried overnight (18 h) in a laboratory oven set at 120±5° C. The dried cake was passed through a disc mill to obtain a powder. This powder was subsequently used for materials and chemical characterization and agronomic studies.

1A. Determination of the MPM:KCl Mineralogy—XRPD

The mineralogy of the MPM:KCl composition in FIGS. 5 and 6 was determined by X-Ray Powder Diffraction (XRPD). Powder samples were back-loaded onto the sample holder and put into a diffractometer (Panalytical X′Pert MPD) that used \ CuK, radiation at 45 kV and 40 mA as an X-ray source. Once identified, mineral phases were quantified via the internal standard method and Rietveld refinement. A few small peaks (1% of the overall diffraction patterns) could not be positively identified and were disregarded. A second XRPD scan was run under the same conditions as the initial scan. In the second scan, 25 wt. % Si (NIST SRM 640) was mixed into the sample to serve as the internal standard. A new Rietveld refinement was performed, permitting a comparison, adjusted for differences in scattering power, between the integrated intensity of the Si peaks and the integrated intensity of the known crystalline phases determined in the initial analysis. The difference between these values as a portion of the total was assumed to be due to the amorphous content of the sample. The final amount of each crystalline constituent is the result of the initial Rietveld refinement normalized to take into account the estimated amorphous content.

Samples showed a high degree of preferred orientation, overlapping peaks and unusual peak shapes, involving extensive manual fitting. Given several sources of uncertainties, XRPD quantitation can be considered only as the best possible estimate.

The diffraction pattern of the MPM:KCl composition is given in FIG. 6 (refinement not shown). XRPD analysis detected K-feldspar (KAlSi₃O₈) and new mineral phases formed in situ during hydrothermal processing and/or drying, namely hydrogrossular (Ca₃Al₂(SiO₄)₃₋ₓ(OH)₄ₓ), α-dicalcium silicate hydrate (Ca₂SiO₃(OH)₂), 11 Å tobermorite (Ca₅Si₆O₁₆(OH)₂.4H₂O) and amorphous material(s).

K-feldspar is the main mineral constituent of the ultrapotassic syenite used in the feed mixture. In the MPM:KCl composition, residual K-feldspar still detected by XRPD accounted for 1-74.5% by weight, tobermorite phase in a range of 0% and 55% by weight (e.g., between 0% and 50% by weight, between 0% and 45% by weight, between 0% and 40% by weight, between 0% and 35% by weight, between 0% and 30% by weight, between 0% and 25% by weight, between 0% and 20% by weight), hydrogrossular phase in a range of between 0% and 15% by weight (e.g., between 0% and 12% by weight), dicalcium silicate hydrate phase in a range of between 0% and 20% by weight (e.g., between 0% and 15% by weight, between 0% and 12% by weight, between 0% and 10% by weight), amorphous phase in a range of between 1% and 55% by weight (e.g., between 1% and 45% by weight), sylvite phase in a range of between 0.1% and 99% by weight and accessories phase in a range of between 0.1% and 20% by weight.

1B. Determination of the Microstructure of MPM:KCl

The MPM:KCl composition mounted in thin sections (27 mm×46 mm, 30 μm thick, two-sided polish 0.5 μm diamond, borosilicate glass, acrylic resin; Spectrum Petrographics Inc.) was observed with a Scanning Electron Microscope (JEOL 6610 LV) operated in high vacuum mode (<10⁻³ Pa). The accelerating voltage was 10-20 kV, the spot size 45-60, and the working distance 9-10 mm. Before observation, sections were carbon coated (Quorum, EMS 150T ES). Thin sections were stored under vacuum.

The chemical composition of the MPM:KCl composition mounted in thin section was determined with an Electron Probe Micro-Analyzer (EPMA) (JEOL JXA-8200), using an accelerating voltage of 15 kV, beam current of 10 nanoAmps (nA) and beam diameter of 1 μm. The mineral phases were analyzed with counting times of 20-40 s. From counting statistics, 1σ standard deviations on concentration values were 0.3-1.0% for major elements and 1.0-5.0% for minor elements. Back-scattered electron (BSE) images and X-Ray elemental maps (4.5 cm×2.7 cm) were obtained using a voltage of 15 kV, a beam current of 1 nA and a resolution of 10 μm. The use of such settings as well as operations in stage-rastered mode with a stationary beam avoided signal loss and defocusing of X-Ray.

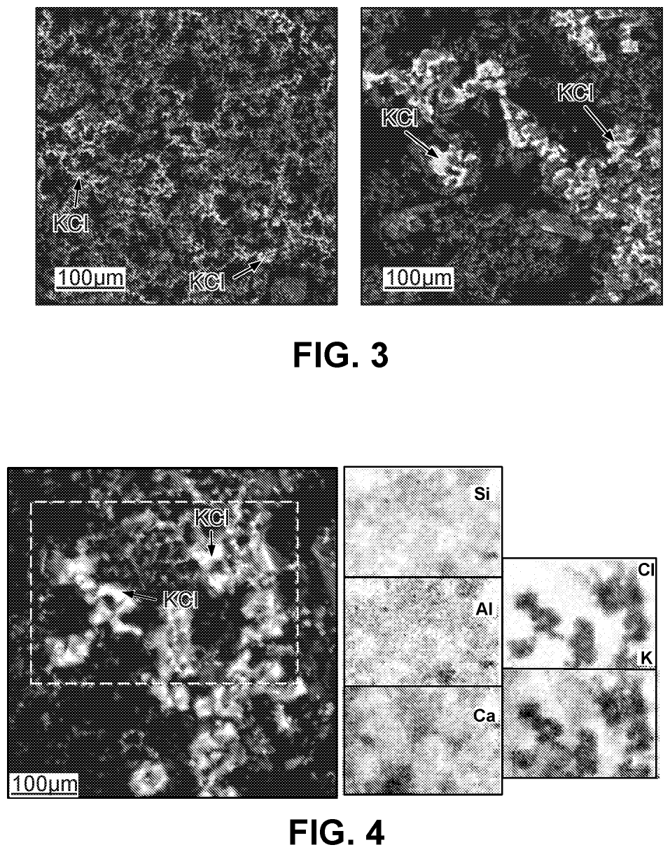

Preliminary SEM observations of the MPM:KCl composition were made on the powder as such (FIG. 3). Subsequently, it was mounted in thin section, for detailed exploration of morphological features (SEM).

Lastly, various mineral phases could contribute to what is detected as amorphous by XRPD such as i) severely altered (disordered) K-feldspar ii) nanocrystalline particles iii) truly amorphous compounds, for example poorly crystallized non-stoichiometric calcium-silicate-hydrate (C-S-H).

The particle size distribution (PSD) of powder samples were determined with a MicroBrook 2000L laser-diffraction particle size analyzer (Brookhaven Instruments Cooperation, US), equipped with a sample circulation and dispersion module. Samples were introduced into the dispersion module until an obscuration of ˜15% was achieved. Samples were dispersed in water by mechanical agitation and sonication prior to each measurement. Refractive indices of 1.529 (real) and 0.1 (imaginary) were used in the optical model.

Specific Surface Area according to Brunauer, Emmet and Teller (BET-SSA) was determined with a Micromeritics ASAP 2020 surface area and porosity analyzer. The gas used for adsorption was N₂. Samples (˜0.5 g) were degassed at 200° C. until a constant degassing rate of 10⁻⁵ mmHg min⁻¹ was reached in the sample tube (12 h). SSA was determined on the adsorption branch of the isotherm with the multi-points method in the p/p₀ range 0.08-0.35. However, the complete adsorption (up to p/p₀=0.99) and desorption isotherms were recorded.

1C. Extraction Experiments

Extraction experiments for ultrapotassic syenite, MPM, and MPM:KCl composition were performed in batches. 0.400 g of solid composition was agitated with 40 mL of extraction solution (m_{L}:m_{S}=100) for 30 min in a sealed polypropylene centrifuge tube. Various extractants were used to vary the intensity of the extraction. Commonly used extractants include 0.1 M citric acid and deionized water. All aqueous solutions were prepared using 18.2 MΩ cm water. After agitation, the extractant solution is isolated through a sequence of centrifugation and filtration. The latter employed a grade 3 Whatman filter paper (6 μm pores). The filtrate is then diluted 1/100 in 2 wt. % HNO₃ for ICP-OES analysis. Each extraction experiment was performed in triplicate.

The MPM:KCl composition releases K⁺ and the amount of K⁺ released from the alkali metal releasing composition after 30 min exposure to a 100-fold excess of 0.1 M citric acid is at least 676-fold higher than the amount of K⁺ released by the one or more potassic framework silicate starting materials under the same extraction conditions. In some embodiments of the present disclosure, the amount of K⁺ released from the MPM:KCl composition after 30 min exposure to a 100-fold excess of 0.1 M citric acid relative to the amount of K⁺ released by the one or potassic framework silicate starting materials under the same extraction conditions is 2-fold higher, 3-fold higher, 4-fold higher, 5-fold higher, 6-fold higher, 7-fold higher, 8-fold higher, 9-fold higher, 10-fold higher, 15-fold higher, 20-fold higher, 25-fold higher, 30-fold higher, 35-fold higher, 40-fold higher, 45-fold higher, 50-fold higher, 55-fold higher, 60-fold higher, 65-fold higher, 110-fold higher, 155-fold higher, 201-fold higher, 246-fold higher, 291-fold higher, 337-fold higher, 382-fold higher, 427-fold higher, 473-fold higher, 518-fold higher, 563-fold higher, 608-fold higher, 654-fold higher, 699-fold higher, 744-fold higher, 790-fold higher, 835-fold higher, 880-fold higher, 925-fold higher, 971-fold higher, 1016-fold higher, 1061-fold higher, 1107-fold higher, 1152-fold higher, 1197-fold higher, 1243-fold higher, or 1288-fold higher, including all values there between.

Also, the MPM:KCl composition releases K⁺ and the amount of K⁺ released from the alkali metal releasing composition after 30 min exposure to a 100-fold excess of deionized water is at least 2650-fold higher than the amount of K⁺ released by the one or more potassic framework silicate starting materials under the same extraction conditions. In some embodiments of the present disclosure, the amount of K⁺ released from the MPM:KCl composition after 30 min exposure to a 100-fold excess of deionized water relative to the amount of K⁺ released by the one or potassic framework silicate starting materials under the same extraction conditions is 2-fold higher, 3-fold higher, 4-fold higher, 5-fold higher, 6-fold higher, 7-fold higher, 8-fold higher, 9-fold higher, 10-fold higher, 15-fold higher, 20-fold higher, 25-fold higher, 30-fold higher, 35-fold higher, 40-fold higher, 45-fold higher, 50-fold higher, 55-fold higher, 60-fold higher, 70-fold higher, 80-fold higher, 90-fold higher, 100-fold higher, 150-fold higher, 336-fold higher, 521-fold higher, 706-fold higher, 891-fold higher, 1076-fold higher, 1262-fold higher, 1447-fold higher, 1632-fold higher, 1817-fold higher, 2002-fold higher, 2188-fold higher, 2373-fold higher, 2558-fold higher, 2743-fold higher, 2928-fold higher, 3113-fold higher, 3299-fold higher, 3484-fold higher, 3669-fold higher, 3854-fold higher, 4039-fold higher, 4225-fold higher, 4410-fold higher, 4595-fold higher, 4780-fold higher, 4965-fold higher, or 5150-fold higher, including all values there between.

1D. Relationship Between Mineralogy Composition and Extraction

The major potassium alumino silicate (KAS) detected by XRPD in the MPM:KCl composition was K-feldspar (KAlSi₃O₈). XRPD showed that approximately 30 wt. % of K-feldspar were converted during processing (FIG. 4). PSD analysis confirmed that the size population attributable to K-feldspar (˜55 μm peak) was reduced in the MPM:KCl composition with respect to the feed mixture (FIG. 8). However, such a mineral phase remains the main constituent of the MPM:KCl composition (25.4 wt. %), and therefore also the main K-bearing phase. This is a carefully engineered and intended feature of the composition. A complete transformation of K-feldspar would be cost prohibitive, and would generate a large amount of soluble K immediately available in the soil solution, in opposition with the declared scope of this work, i.e. engineering a fertilizer (e.g., a fertilizer for soils, such as a fertilizer for tropical soils) with a K-release rate that fits crop needs or desires.

The hydrothermal process transforms K-feldspar into Ca-bearing aluminosilicate hydrates, namely hydrogrossular, tobermorite, α-dicalciumsilicate hydrate, and disordered C-A-S-H phases, wherein the latter falls into the category of XRPD amorphous (FIGS. 5 and 6). One or more of these Ca-bearing aluminosilicate hydrates has the ability to host K, serving as a K reservoir. As shown in Table 1, a sufficiently acidic environment—similar to those found in the rhizosphere—will dissolve these phases to release K and other stored nutrients and/or beneficial elements.

### Example 2: Effect of Processing and Drying Conditions on the MPM:KCl Composition K-Release from MPM:KCl Composition Under Different Drying Conditions

Extraction experiments were carried out as follows: 400 mg of MPM or equivalent amount of MPM:KCl composition were suspended in 40 mL of 0.1 M citric acid solution (done in triplicates). The pHₜ₌₀ was recorded. Samples were then agitated for 30 min and a second pH measurement was taken (pHₜ₌₂₄ₕ). Extraction of minerals was determined by ICP-MS under acidic conditions (2 wt. % HNO₃). Except where noted, MPM:KCl composition were processed at 220° C. and dried under the specified conditions at 120° C.

The methods provide an MPM:KCl composition, wherein the amount of K⁺ released from the MPM:KCl composition after 30 min exposure to a 100-fold excess of 0.1 M citric acid ranges from about 0.4 to about 520 g K⁺/kg MPM:KCl composition. In certain embodiments, the amount of K⁺ released was about 0.4 g K⁺/kg MPM:KCl composition, about 1 g K⁺/kg MPM:KCl composition, about 5 g K⁺/kg MPM:KCl composition, about 10 g K⁺/kg MPM:KCl composition, about 25 g K⁺/kg MPM:KCl composition, about 50 g K⁺/kg MPM:KCl composition, about 100 g K⁺/kg MPM:KCl composition, about 130 g K⁺/kg MPM:KCl composition, about 160 g K⁺/kg MPM:KCl composition 1, about 190 g K⁺/kg MPM:KCl composition, about 210 g K⁺/kg MPM:KCl composition, about 240 g K⁺/kg MPM:KCl composition, about 270 g K⁺/kg MPM:KCl composition, about 300 g K⁺/kg MPM:KCl composition, about 400 g K⁺/kg MPM:KCl composition, about 500 g K⁺/kg MPM:KCl composition, about 520 g K⁺/kg MPM:KCl composition, including all values and ranges there between.

The methods provide an MPM:KCl composition, wherein the amount of K⁺ released from the MPM:KCl composition after 30 min exposure to a 100-fold excess of deionized ranges from about 0.2 to about 520 g K⁺/kg MPM:KCl composition. In certain embodiments, the amount of K⁺ released was about 0.2 g K⁺/kg MPM:KCl composition, about 0.4 g K⁺/kg MPM:KCl composition, about 1 g K⁺/kg MPM:KCl processed composition, about 5 g K⁺/kg MPM:KCl composition, about 10 g K⁺/kg MPM:KCl composition, about 25 g K⁺/kg MPM:KCl composition, about 50 g K⁺/kg MPM:KCl composition, about 100 g K⁺/kg MPM:KCl composition, about 130 g K⁺/kg MPM:KCl composition, about 160 g K⁺/kg MPM:KCl composition, about 190 g K⁺/kg MPM:KCl composition, about 210 g K⁺/kg MPM:KCl composition, about 240 g K⁺/kg MPM:KCl composition, about 270 g K⁺/kg MPM:KCl composition, about 300 g K⁺/kg MPM:KCl composition, about 400 g K⁺/kg MPM:KCl composition, about 500 g K⁺/kg MPM:KCl composition, about 520 g K⁺/kg MPM:KCl composition, including all values and ranges there between.

The composition as described herein can be produced by granulation with a feed of MPM and KCl.

The MPM:KCl composition as described herein can possess a rhizosphere-responsive K release, wherein one portion of K⁺ is water-soluble salt, while additional portions are released over an extended period of time. Therefore, in some embodiments, the MPM:KCl composition disclosed herein can possess the desirable property of having both fast-release K and slow-release K. In various embodiments of the present disclosure, the ratio of immediate-release (soluble) K to slow (solid phase) K in the MPM:KCl composition is from about 720:1 to about 0.01:1. In some embodiments, the ratio is about 720:1, about 700:1, about 600:1, about 500:1, about 400:1, about 300:1, about 200:1, about 100:1, about 50:1, about 10:1, about 9:1, about 8:1, about 7:1, about 6:1, about 5:1, about 4:1, about 3:1, about 2:1, about 1:1, about 0.8:1, about 0.6:1, about 0.4:1, about 0.2:1, about 0.1:1, or about 0.01:1 including all ranges and values there between.

A series of MPM:KCl compositions were produced using four distinct sets of atmospheric conditions (Ar-Ar, Ar-Air, Air-Air, and CO₂—CO₂) for reacting the feedstocks and subsequently drying the resulting products (Table 2).

TABLE 2
Mineral ranges for MPM:KCl composition

| MPM phase distribution | Low conv. | Low buffer | Std. conv. | High buffer |
|---|---|---|---|---|
| Weight percent of K-feldspar | 55.7% | 75.2% | 44.5% | 28.9% |
| Weight percent of tobermorite | — | — | 5.0% | 6.8% |
| Weight percent of hydrogarnet | 6.2% | 4.0% | 7.0% | 9.5% |
| Weight percent of DCS | 8.2% | 5.3% | — | — |
| Weight percent of amorphous | 23.3% | 15.1% | 33.1% | 44.7% |
| Sub-total | 93.4% | 99.7% | 89.6% | 89.8% |
| Accessory | 6.6% | 0.3% | 10.4% | 10.2% |
| Total | 100.0% | 100.0% | 100.0% | 100.0% |
| 0.01H:1M | | | | |
| Weight of MPM | 0.01 | 0.01 | 0.01 | 0.01 |
| Weight of KCl | 1 | 1 | 1 | 1 |
| Weight percent of MPM | 0.99% | 0.99% | 0.99% | 0.99% |
| Weight percent of KCl | 99.01% | 99.01% | 99.01% | 99.01% |
| MPM phases | | | | |
| Weight percent of K-feldspar | 0.551% | 0.745% | 0.441% | 0.286% |
| Weight percent of tobermorite | 0.000% | 0.000% | 0.050% | 0.067% |
| Weight percent of hydrogarnet | 0.061% | 0.040% | 0.069% | 0.094% |
| Weight percent of DCS | 0.081% | 0.053% | 0.000% | 0.000% |
| Weight percent of amorphous | 0.231% | 0.150% | 0.328% | 0.442% |
| Weight percent of accessory phases | 0.065% | 0.003% | 0.103% | 0.101% |
| 1H:1M | | | | |
| Weight of MPM | 1 | 1 | 1 | 1 |
| Weight of KCl | 1 | 1 | 1 | 1 |
| Weight percent of MPM | 50.00% | 50.00% | 50.00% | 50.00% |
| Weight percent of KCl | 50.00% | 50.00% | 50.00% | 50.00% |
| MPM phases | | | | |
| Weight percent of K-feldspar | 27.850% | 37.598% | 22.250% | 14.463% |
| Weight percent of tobermorite | 0.000% | 0.000% | 2.500% | 3.375% |
| Weight percent of hydrogarnet | 3.100% | 2.015% | 3.500% | 4.725% |
| Weight percent of DCS | 4.100% | 2.665% | 0.000% | 0.000% |
| Weight percent of amorphous | 11.650% | 7.573% | 16.550% | 22.343% |
| Weight percent of accessory phases | 3.300% | 0.150% | 5.200% | 5.095% |
| 2H:1M | | | | |
| Weight of MPM | 2 | 2 | 2 | 2 |
| Weight of KCl | 1 | 1 | 1 | 1 |
| Weight percent of MPM | 66.67% | 66.67% | 66.67% | 66.67% |
| Weight percent of KCl | 33.33% | 33.33% | 33.33% | 33.33% |
| MPM phases | | | | |
| Weight percent of K-feldspar | 37.133% | 50.130% | 29.667% | 19.283% |
| Weight percent of tobermorite | 0.000% | 0.000% | 3.333% | 4.500% |
| Weight percent of hydrogarnet | 4.133% | 2.687% | 4.667% | 6.300% |
| Weight percent of DCS | 5.467% | 3.553% | 0.000% | 0.000% |
| Weight percent of amorphous | 15.533% | 10.097% | 22.067% | 29.790% |
| Weight percent of accessory phases | 4.400% | 0.200% | 6.933% | 6.793% |
| 3H:1M | | | | |
| Weight of MPM | 3 | 3 | 3 | 3 |
| Weight of KCl | 1 | 1 | 1 | 1 |
| Weight percent of MPM | 75.00% | 75.00% | 75.00% | 75.00% |
| Weight percent of KCl | 25.00% | 25.00% | 25.00% | 25.00% |
| MPM phases | | | | |
| Weight percent of K-feldspar | 41.775% | 56.396% | 33.375% | 21.694% |
| Weight percent of tobermorite | 0.000% | 0.000% | 3.750% | 5.063% |
| Weight percent of hydrogarnet | 4.650% | 3.023% | 5.250% | 7.088% |
| Weight percent of DCS | 6.150% | 3.998% | 0.000% | 0.000% |
| Weight percent of amorphous | 17.475% | 11.359% | 24.825% | 33.514% |
| Weight percent of accessory phases | 4.950% | 0.225% | 7.800% | 7.642% |
| 5H:1M | | | | |
| Weight of MPM | 5 | 5 | 5 | 5 |
| Weight of KCl | 1 | 1 | 1 | 1 |
| Weight percent of MPM | 83.33% | 83.33% | 83.33% | 83.33% |
| Weight percent of KCl | 16.67% | 16.67% | 16.67% | 16.67% |
| MPM phases | | | | |
| Weight percent of K-feldspar | 46.417% | 62.663% | 37.083% | 24.104% |
| Weight percent of tobermorite | 0.000% | 0.000% | 4.167% | 5.625% |
| Weight percent of hydrogarnet | 5.167% | 3.358% | 5.833% | 7.875% |
| Weight percent of DCS | 6.833% | 4.442% | 0.000% | 0.000% |
| Weight percent of amorphous | 19.417% | 12.621% | 27.583% | 37.238% |
| Weight percent of accessory phases | 5.500% | 0.250% | 8.667% | 8.492% |
| 100H:1M | | | | |
| Weight of MPM | 100 | 100 | 100 | 100 |
| Weight of KCl | 1 | 1 | 1 | 1 |
| Weight percent of MPM | 99.01% | 99.01% | 99.01% | 99.01% |
| Weight percent of KCl | 0.99% | 0.99% | 0.99% | 0.99% |
| MPM phases | | | | |
| Weight percent of K-feldspar | 55.149% | 74.450% | 44.059% | 28.639% |
| Weight percent of tobermorite | 0.000% | 0.000% | 4.950% | 6.683% |
| Weight percent of hydrogarnet | 6.139% | 3.990% | 6.931% | 9.356% |
| Weight percent of DCS | 8.119% | 5.277% | 0.000% | 0.000% |
| Weight percent of amorphous | 23.069% | 14.995% | 32.772% | 44.243% |
| Weight percent of accessory phases | 6.535% | 0.297% | 10.297% | 10.089% |

Altering the processing and drying atmosphere markedly influences the composition of the MPM:KCl composition produced. In particular, the amount of the amorphous phase, dicalcium silicate hydrate, hydrogarnet, tobermorite, and K-feldspar vary under each set of conditions.

Further studies were conducted to isolate the effects of the drying conditions on extraction of potassium from two sets of MPM:KCl composition. For the first set, the MPM:KCl composition was dried with the supernatant separately using air, Ar, CO₂, and vacuum. K-release is highest under Ar conditions and lowest when CO₂ is utilized. Application of vacuum between 10⁻²-10⁻³ Torr also provides substantial release of K⁺ from the MPM:KCl composition. Drying with air provides an intermediate value, clearly indicating that the small amount of CO₂ naturally present has little impact on extraction. In these experiments, K-release was found to be independent of drying temperature (<90° C.).

### Example 3: Salinity Index

The weight ratio of MPM:KCl composition are variables found to impact the salinity index of compositions (Table 3 and 4). For instance, decreasing the MPM weight ratio will increases the salinity index (Table 3 and 4). As MPM is chloride-free, a MPM:KCl composition would significantly reduce the Cl added into the soil, compared with KCl. For example, MPM:KCl composition (1:1) reduces the salinity by 50% (compared with KCl) and the resulting salinity index is similar to commercial fertilizers K₂SO₄ and Poly 4.

TABLE 3
Salinity index and percentage of K⁺ and Cl⁻ of different weight ratios of MPM:KCl composition.

| Blend properties | MPM:KCl Blends | | | | | | | | K₂SO₄ | “Poly4” |
|---|---|---|---|---|---|---|---|---|---|---|
| Weight of MPM | 1 | 100 | 10 | 5 | 3 | 1 | 1 | — | — | — |
| Weight of K-bearinq salt | — | 1 | 1 | 1 | 1 | 1 | 10 | 1 | 1 | 1 |
| MPM contribution in weight | 100% | 99.0% | 90.9% | 83.8% | 75.0% | 50.0% | 9.1 | 0.00% | — | — |
| Calculated Salinity Index | 5.0 | 6.2 | 16.4 | 25.8 | 36.3 | 67.5 | 118.6 | 130.0 | 50.0 | 76.0 |
| Weight percent of K in blend | 8.3% | 8.7% | 12.3% | 15.6% | 19.2% | 30.2% | 48.0% | 52.0% | 41.5% | 11.6% |
| Weight percent of Cl in blend | 0.0% | 0.5% | 4.4% | 8.0% | 12.0% | 24.0% | 43.6% | 48.0% | — | — |

TABLE 4
The Salinity index measurements of MPM:KCl composition prepared
via method 2 in FIG. 2 (DRY) and method 3 in FIG. 2 (PWD).

| | | | | Calculated salinity | Calcuated salinity |
|---|---|---|---|---|---|
| | Concentration | Conductivity | | index from known | index from |
| Sample | (g/L) | (mS/cm) | T(° C.) | values (%) | measurements (%) |
| NaNO3 | 10 | 11.64 | 20.6 | 100.00 | 100.00 |
| KCl | 10 | 17.5 | 20.5 | 130.00 | 150.34 |
| 1:1, MPM; KCl - DRY | 10 | 8.8 | 20.6 | 67.50 | 75.60 |
| 3:1, MPM; KCl - DRY | 10 | 4.75 | 20.5 | 36.25 | 40.81 |
| 5:1, MPM; KCl - DRY | 10 | 3.33 | 20.6 | 20.83 | 28.61 |
| 10:1, MPM; KCl - DRY | 10 | 2.04 | 20.5 | 13.64 | 17.53 |
| MPM | 10 | 0.758 | 20 | 5.00 | 6.51 |
| 1:1, MPM; KCl - PWD | 10 | 9.37 | 20.3 | 67.50 | 80.50 |
| 3:1, MPM; KCl - PWD | 10 | 5.09 | 20.6 | 20.83 | 43.73 |
| 10:1. MPM; KCl - PWD | 10 | 2.42 | 20.4 | 13.64 | 20.79 |

Relative SI, Powder blend vs. Dry blend

| | Relative SI, Powder |
|---|---|
| Sample | blend vs. Dry blend |
| 1:1, MPM; KCl | 1.09 |
| 3:1, MPM; KCl | 1.03 |
| 10:1, MPM; KCl | 1.11 |

### Example 4: Processing Parameters and Agronomic Efficiency

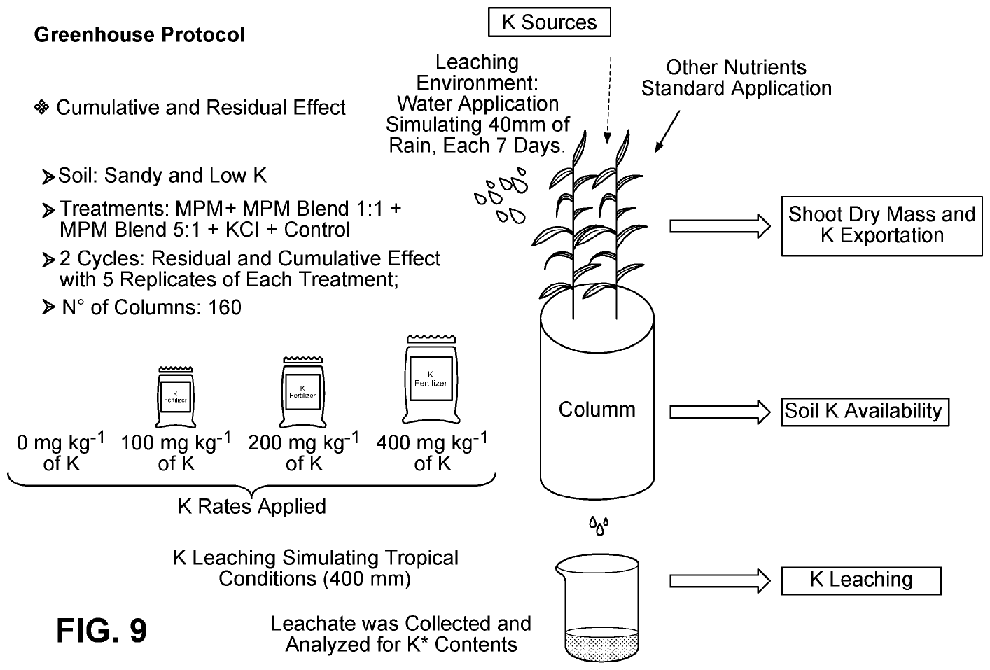

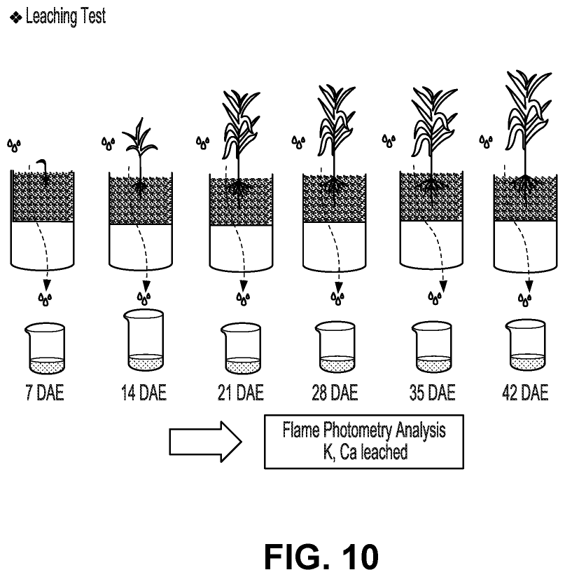

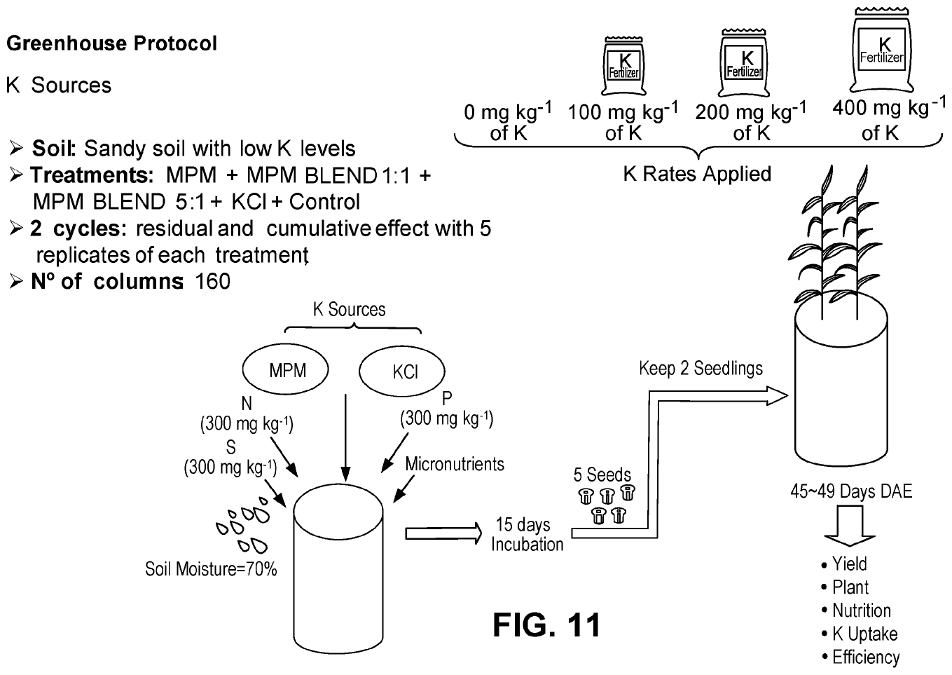

The greenhouse tests for yield comparison (both the first as well as the second cycle) and K leaching loss comparison were performed in columns containing a sandy and low K soil treated with different K sources, MPM, 5-MPM:1-KCl, 1-MPM:1-KCl, KCl (commercially named Muriate of Potash (MOP)) and control (with 5 replicates of each treatment) as illustrated in FIG. 9 and FIG. 11. Each composition/product was tested at three different K rates with the remaining necessary macronutrients incorporated directly into the soil in the amounts as per Tables 5A and 5B below. The moisture level of the soil was increased to 70%, followed by incubation for 15 days. After incubation, five seeds were planted. After emergence of the seedlings, two of them were kept and grown over a period of 45-49 days to provide yield, plant nutrition, K uptake and efficiency data. The micronutrients were added as part of a nutrient solution during the growth cycle as per Table 5A. Over the growth cycle, water was applied to simulate 40 mm of rain spread over every seven day period. The first greenhouse cycle finished with the harvesting and analysis of the crops of each column. After the first greenhouse cycle but before the second greenhouse cycle, the soil was treated according to the same protocol, including incubation, with the only difference being that certain macronutrients were added in a slightly different proportion when compared to the first cycle as per Tables 5A and 5B below. The micronutrients added remained the same. Concurrent with the growth of the plants, the leachate collected at the bottom of the columns was analyzed over regular intervals for its K content (FIG. 10). The K that was in the leachate was considered as permanently lost as it could not be absorbed by the roots of the plants within this cycle anymore, and would also not contribute to build-up the nutrient reservoir of the soil.

TABLE 5A
First greenhouse cycle added macro and micronutrients

| | | Elements | | g/pot |
|---|---|---|---|---|
| | | doses | | of each |
| | Nutrients | (mg/kg) | Sources | source |
| MACRO | P | 250 | MAP (27.2% of P) | 5.64 |
| | N | 150 | Urea | 0.50 |
| | Mg | 45.2 | Lime (dolomitic) | 2.50 |
| | Ca | 120.5 | Gypsum (16% Ca; 13% S) | 1.17 |
| | S | 30 | | |
| MICRO | B | 0.5 | H₃BO₃ | 0.017 |
| | Cu | 2.0 | CuSO₄ 5H₂O | 0.047 |
| | Mn | 3.0 | MnSO₄ H₂O | 0.055 |
| | Zn | 4.0 | ZnSO4•7H2O | 0.102 |
| | Mo | 0.25 | (NH₄)6Mo₇O₂₄•4H₂O | 0.003 |

TABLE 5B
Second greenhouse cycle added macronutrients

| | | Elements | | g/pot |
|---|---|---|---|---|
| | | doses | | of each |
| | Nutrients | (mg/kg) | Sources | source |
| MACRO | P | 250 | MAP (27.2% of P) | 5.64 |
| | N | 150 | Urea | 0.50 |
| | Mg | 20.0 | Magnesium sulfate | 1.33 |
| | | | (9% Mg; 12% S) | |
| | Ca | 40.0 | Gypsum (16% Ca; 13% S) | 1.50 |
| | S | 63.9 | | |

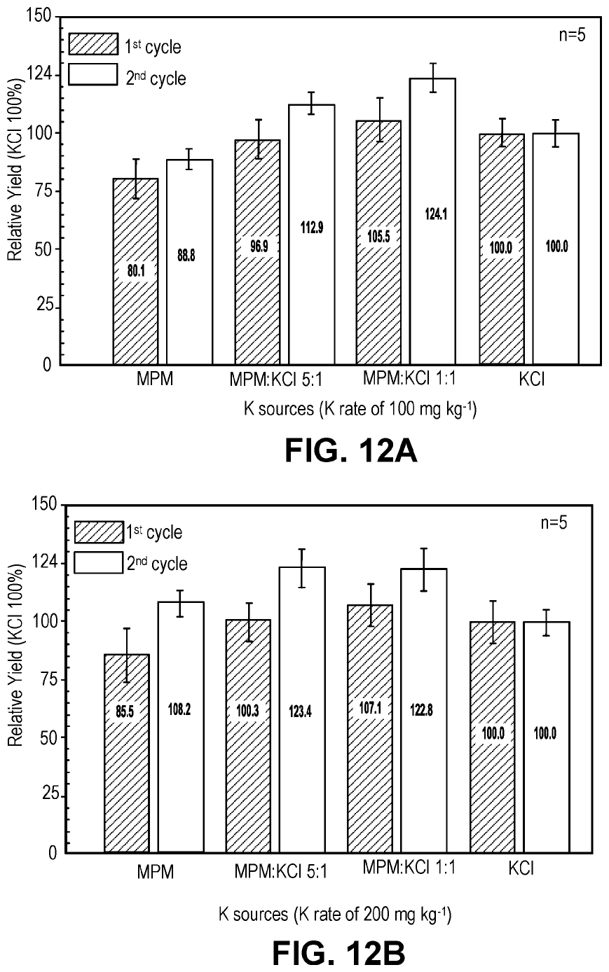

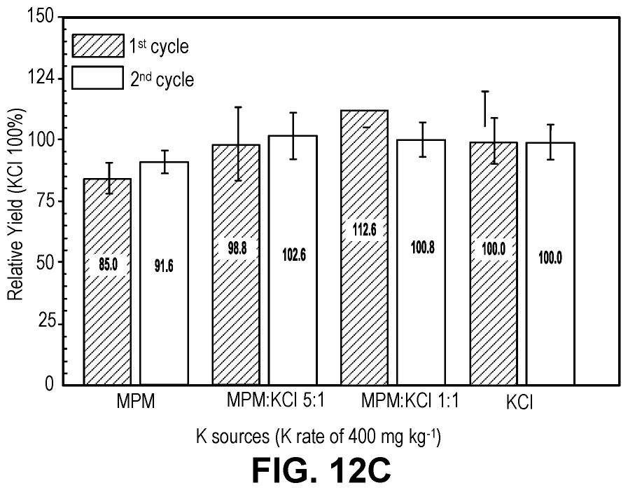

In FIGS. 12A-C, the greenhouse protocol was used to grow a first cycle of corn, after which the crops were removed, with the aerial part dried for agronomic efficiency analysis. The resulting soil was used to grow corn for a second cycle. FIGS. 12A-C show that compositions disclosed herein can exhibit a significant yield increase when compared to KCl alone. Moreover, compositions disclosed herein demonstrate a comparative yield increase after successive applications (i.e., comparing results from the first vs. second cycle). MPM:KCl composition proved itself as an efficient option to provide the right K source, at the right time, being the right rate to the right place, achieving the efficiency for crop systems growth (4R stewardship) (FIGS. 12A-C).

Table 6 below shows additional data on the leaching properties of compositions according to the disclosure. The data were collected at 42 DAE from the leachate using flame photometry. The analyzed leachate (FIG. 10) shows the K leaching losses when comparing different compositions. In the experiment with a K rate of 200, implying a total of 1200 mg of K per column, only 1.1% of the K, added to the column in the form of MPM, was lost through leaching and ended in the leachate after the greenhouse cycle. In order to calculate the 1.1%, the 28 mg of K lost through leaching in the control column was subtracted from the 41 mg of K lost through leaching in the column containing MPM. The column with the composition of MPM:KCL 5:1 lost 4.3% of its K content, while the column with the composition of MPM:KCL 1:1 lost 13.8% of its K content through leaching. As a comparison, the column containing KCl lost 16.8% of its K content, demonstrating that compositions of MPM:KCl help reduce leaching losses. All percentages were calculated by subtracting the 28 mg K leaching loss from the control. Leachate measurements were only taken during the first greenhouse cycle.

In the scenario with a K rate of 400, implying a total of 2400 mg of K per column, results of different compositions were even more expressive. The column with MPM only lost 3.0% of its K through leaching. The column with the composition of MPM:KCL 5:1 lost 12.1% of its K content, while the column with the composition of MPM:KCL 1:1 lost 26.2% of its K content through leaching compared to 39.1% of the column containing KCl only. With higher K doses, while losses through leaching from KCl are significant, pure MPM and compositions of MPM:KCl reduce these losses significantly.

TABLE 6
K Leaching Data

| | | | | |
|---|---|---|---|---|
| Control | MPM | MPM:KCl 5:1 | MPM:KCl 1:1 | KCl |

K sources (K rate of 200) 1200 mg/column

| | | | | | |
|---|---|---|---|---|---|
| Shoot dry weight (g per column) | 28.9 | 64.1 | 75.2 | 80.3 | 75.0 |
| Relative Yield to KCl (KCl = 100%) | 38.6% | 85.5% | 100.3% | 107.1% | 100.0% |
| Total leached K per column (mg) | 28 | 41 | 79 | 194 | 229 |
| Total leached K % (less control) | | 1.1% | 4.3% | 13.8% | 16.8% |

K sources (K rate of 400) 2400 mg/column

| | | | | | |
|---|---|---|---|---|---|
| Shoot dry weight (g per column) | 28.9 | 55.7 | 64.7 | 73.8 | 65.5 |
| Relative Yield to KCl (KCl = 100%) | 44.1% | 85.0% | 94.5% | 112.6% | 100.0% |
| Total leached K per column (mg) | 28 | 99 | 318 | 656 | 966 |
| Total leached K % (less control) | | 3.0% | 12.1% | 26.2% | 39.1% |

### OTHER EMBODIMENTS

While certain embodiments have been described, the disclosure is not limited to such embodiments.

As an example, while the amount of K-feldspar phase has been described for certain MPM:KCl compositions, more generally, a composition including one or more components in addition to, or instead of, KCl can include at least about 1 wt. % (e.g., at least about 2 wt. %, at least about 3 wt. %, at least about 4 wt. %, at least about 5 wt. %, at least about 6 wt. %, at least about 7 wt. %, at least about 8 wt. %, at least about 9 wt. %, at least about 10 wt. %, at least about 11 wt. %, at least about 12 wt. %, at least about 13 wt. %, at least about 14 wt. %, at least about 15 wt. %, at least about 16 wt. %, at least about 17 wt. %, at least about 18 wt. %, at least about 19 wt. %, at least about 20 wt. %, at least about 21 wt. %, at least about 22 wt. %, at least about 23 wt. %, at least about 24 wt. %, at least about 25 wt. %, at least about 26 wt. %, at least about 27 wt. %, at least about 28 wt. %, at least about 29 wt. %, at least about 30 wt. %) K-feldspar phase and/or at most about 74.5 wt. % (e.g., at most about 70 wt. %, at most about 65 wt. %, at most about 60 wt. %, at most about 55 wt. %, at most about 50 wt. %, at most about 45 wt.; %, at most about 40 wt. %, at most about 35 wt. %, at most about 30 wt. %, at most about 25 wt. %, at most about 20 wt. %) K-feldspar phase, including all ranges between these values. In some embodiments, a composition including one or more components in addition to, or instead of, KCl can include K-feldspar phase in an amount of about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, about 35 wt. %, about 40 wt. %, about 45 wt. %, about 50 wt. %, about 55 wt. %, about 60 wt. %, about 65 wt. %, about 70 wt. %, about 74.5 wt. %.

As another example, a composition including one or more components in addition to, or instead of, KCl can include at least about 1 wt. % (e.g., at least about 2 wt. %, at least about 3 wt. %, at least about 4 wt. %, at least about 5 wt. %, at least about 6 wt. %, at least about 7 wt. %, at least about 8 wt. %, at least about 9 wt. %, at least about 10 wt. %, at least about 15 wt. %, at least about 20 wt. %, at least about 25 wt. %, at least about 30 wt. %) tobermorite phase and/or at most about 55 wt. % (e.g., at most about 50 wt. %, at most about 45 wt. %, at most about 40%, at most about 35 wt. %, at most about 30 wt. %, at most about 25 wt. %) tobermorite phase, including all ranges between any of these values. In certain embodiments, a composition including one or more components in addition to, or instead of, KCl can include tobermorite phase in an amount of about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 15 wt. %, about 20 wt. %, about 25 wt. %, about 30 wt. %, about 40 wt. %, about 45 wt. %, about 50%, or about 55 wt. %.

As a further example, a composition including one or more components in addition to, or instead of, KCl can include at least about 1 wt. % (e.g., at least about 2 wt. %, at least about 3 wt. %, at least about 4 wt. %, at least about 5 wt. %, at least about 6 wt. %, at least about 7 wt. %, at least about 8 wt. %, at least about 9 wt. %, at least about 10 wt. %) hydrogrossular phase and/or at most about 15 wt. % (e.g., at most about 14 wt. %, at most about 13 wt. %, at most about 12 wt. %, at most about 11 wt. %, at most about 10 wt. %) hydrogrossular phase, including all ranges between any of these values. In certain embodiments, a composition including one or more components in addition to, or instead of, KCl can include hydrogrossular phase in an amount of about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, or about 10 wt. %.

As an additional example, a composition including one or more components in addition to, or instead of, KCl can include at least about 1 wt. % (e.g., at least about 2 wt. %, at least about 3 wt. %, at least about 4 wt. %, at least about 5 wt. %, at least about 6 wt. %, at least about 7 wt. %, at least about 8 wt. %, at least about 9 wt. %, at least about 10 wt. %, at least about 11 wt. %, at least about 12 wt. %, at least about 13 wt. %, at least about 14 wt. %, at least about 15 wt. %) dicalcium silicate hydrate phase and/or at most about 20 wt. % (e.g., at most about 19 wt. %, at most about 18 wt. %, at most about 17 wt. %, at most about 16 wt. %, at most about 15 wt. %) dicalcium silicate hydrate phase, including all ranges between any of these values. In certain embodiments, a composition including one or more components in addition to, or instead of, KCl can include dicalcium silicate hydrate phase in an amount of about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, or about 20 wt. %.

As another example, a composition including one or more components in addition to, or instead of, KCl can include at least about 1 wt. % (e.g., at least about 2 wt. %, at least about 3 wt. %, at least about 4 wt. %, at least about 5 wt. %, at least about 6 wt. %, at least about 7 wt. %, at least about 8 wt. %, at least about 9 wt. %, at least about 10 wt. %, at least about 11 wt. %, at least about 12 wt. %, at least about 13 wt. %, at least about 14 wt. %, at least about 15 wt. %, at least about 16 wt. %, at least about 17 wt. %, at least about 18 wt. %, at least about 20 wt. %, at least about 22 wt. %, at least about 24 wt. %, at least about 26 wt. %, at least about 28 wt. %, at least about 30 wt. %) amorphous phase and/or at most about 55 wt. % (e.g. at most about 50 wt. %, at most about 45 wt. %, at most about 40 wt. %, at most about 38 wt. %, at most about 36 wt. %, at most about 34 wt. %, at most about 32 wt. %, at most about 30 wt. %, at most about 28 wt. %, at most about 26 wt. %, at most about 24 wt. %, at most about 22 wt. %, at most about 20 wt. %) amorphous phase, including all ranges between any of these values. In some embodiments, a composition including one or more components in addition to, or instead of, KCl can include amorphous phase in an amount of about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 20 wt. %, about 22 wt. %, about 24 wt. %, about 26 wt. %, about 28 wt. %, about 30 wt. %, about 32 wt. %, about 34 wt. %, about 36 wt. %, about 38 wt. %, about 40 wt. %, about 45 wt. %, about 50 wt. %, or about 55 wt. %.

As yet another example, a composition including one or more components in addition to, or instead of, KCl can include K-feldspar phase in a range of between about 1% and 74.5% by weight (e.g., between about 14.5 and 74.5% by weight), tobermorite phase in a range of 0% and 55% by weight (e.g., between 0% and 50% by weight, between 0% and 45% by weight, between 0% and 40% by weight, between 0% and 35% by weight, between 0% and 30% by weight, between 0% and 25% by weight, between 0% and 20% by weight), hydrogrossular phase in a range of between 0% and 15% by weight (e.g., between 0% and 12% by weight, between 1% and 15% by weight, between 1% and 12% by weight), dicalcium silicate hydrate phase in a range of between 0% and 20% by weight (e.g., between 0% and 15% by weight, between 0% and 12% by weight, between 0% and 10% by weight, between 1% and 20% by weight, between 1% and 15% by weight, between 1% and 12% by weight, between 1% and 10% by weight), and/or amorphous phase in a range of between 1% and 55% by weight (e.g., between 1% and 45% by weight).

As a further example, while embodiments of the weight ratios for certain MPM:KCl compositions have been described, more generally, for a given component in a composition, the weight ratio of MPM:component in the composition is at least 0.01:1 (e.g., at 0.05:1, at least 0.1:1, at least 0.2:1, at least 0.3:1, at least 0.4:1, at least 0.5:1, at least 0.6:1, at least 0.7:1, at least 0.8:1, at least 0.9:1) and/or at most 100:1 (e.g., at most 90:1, at most 80:1, at most 70:1, at most 60:1, at most 50:1, at most 40:1, at most 30:1, at most 20:1, at most 10:1, at most 1:1). In some embodiments, for a given component, the weight ratio of MPM:component in the composition is between 0.01:1 and 100:1. In certain embodiments, for a given component in a composition, the weight ratio of the MPM:component in the composition is between 0.1:1 and 20:1.

As still a further example, while CEC values have been provided for certain MPM:KCl compositions, more generally, a composition including one or more components in addition to, or instead of, KCl can have a CEC of at least 10 millimoles per kilogram (mmolc/kg) (e.g., at least 15 mmolc/kg, at least 20 mmolc/kg, at least 25 mmolc/kg, at least 30 mmolc/kg, at least 35 mmolc/kg, at least 40 mmolc/kg, at least 45 mmolc/kg, at least 50 mmolc/kg, at least 55 mmolc/kg, at least 60 mmolc/kg, at least 65 mmolc/kg, at least 70 mmolc/kg, at least 75 mmolc/kg, at least 80 mmolc/kg, at least 85 mmolc/kg, at least 90 mmolc/kg, at least 95 mmolc/kg, at least 100 mmolc/kg, at least 125 mmol/kg, at least 150 mmolc/kg, at least 175 mmol/kg, and/or at least 200 mmolc/kg) and/or at most 500 mmolc/kg (e.g., at most 450 mmolc/kg, at most 400 mmolc/kg, at most 350 mmolc/kg, at most 300 mmolc/kg, at most 250 mmolc/kg, at most 200 mmol/kg).

Additional embodiments are encompassed by the claims.

1. A method, comprising:
heating at a temperature of at least 90° C. for a time of at least 10 minutes and a pressure of at least one atmosphere: 1) a potassic framework silicate ore; 2) at least one material selected from the group consisting of an oxide, a hydroxide, and a carbonate of at least one of an alkaline earth metal and an alkali metal; and 3) water, thereby producing a first product;
combining the first product with a source of a component to form a second product; and
drying the second product to provide a composition comprising an MPM and the component,
wherein the source of the component comprises at least one member selected from the group consisting of KCl, a macronutrient source, a micronutrient source and a source of a beneficial element.

2. A method, comprising:
heating at a temperature of at least 90° C. for a time of at least 10 minutes and a pressure of at least one atmosphere: 1) a potassic framework silicate ore; 2) at least one material selected from the group consisting of an oxide, a hydroxide, and a carbonate of at least one of an alkaline earth metal and an alkali metal; and 3) water, thereby producing a first product;
drying the first product to provide a second product; and
combining the second product with a source of a component to provide a composition comprising the MPM and the component,
wherein the source of the component comprises at least one member selected from the group consisting of KCl, a macronutrient source, a micronutrient source and a source of a beneficial element.

3. A method, comprising:
heating at a temperature of at least 90° C. for a time of at least 10 minutes and a pressure of at least one atmosphere: 1) a potassic framework silicate ore; 2) at least one material selected from the group consisting of an oxide, a hydroxide, and a carbonate of at least one of an alkaline earth metal and an alkali metal; 3) water; and 4) a source of a component, thereby producing a first product; and
drying the first product to provide a composition comprising an MPM and the component,
wherein the source of the component comprises at least one member selected from the group consisting of KCl, a macronutrient source, a micronutrient source and a source of a beneficial element.

4. The method of claim 1, wherein the at least one material comprises at least two materials selected from the group consisting of an oxide, a hydroxide and a carbonate of at least one of an alkaline earth metal and an alkali metal.

5. The method of claim 1, wherein the at least one material comprises an oxide, a hydroxide, and a carbonate of at least one of an alkaline earth metal and an alkali metal.

6. The method of claim 1, wherein the pressure is at most 300 atmospheres.

7. The method of claim 1, wherein the temperature is at most 400° C.

8. The method of claim 1, wherein the time is at most six hours.

9. The method of claim 1, wherein the first product comprises a slurry comprising a precursor of the MPM.

10. The method of claim 2, wherein the second product comprises the MPM.

11. The method of claim 1, wherein drying is performed at a temperature of at least between 25° C.

12. The method of claim 1, wherein drying is performed at a temperature of at most 200° C.

13. The method of claim 1, wherein drying occurs at a pressure of at least one atmosphere.

14. The method of claim 1, wherein drying occurs at a pressure of at most 100 atmospheres.

15. The method of claim 1, wherein drying occurs for at least 0.01 hour.

16. The method of claim 1, wherein drying occurs for at most 72 hours.

17. The method of claim 1, wherein heating occurs in an autoclave.

18. The method of claim 1, wherein the potassic framework silicate ore comprises at least one member selected from the group consisting of K-feldspar, kalsilite, nepheline, trachyte, rhyolite, ultrapotassic syenite, leucite, nepheline syenite, phonolite, fenite, aplite and pegmatite.

19. The method of claim 1, wherein the potassic framework silicate ore comprises K-feldspar.

20. The method of claim 1, wherein the at least one material comprises at least one member selected from the group consisting of lithium (Li), sodium (Na), and potassium (K), beryllium (Be), magnesium (Mg), calcium (Ca), strontium (Sr).

21.-114. (canceled)
